(19) United States
(12) Patent Application Publication
(10) Pub. No.: US 2014/0347367 A1
(43) Pub. Date: Nov. 27, 2014

(54) DISPLAY PROCESSING APPARATUS, SYSTEM AND COMPUTER-READABLE STORAGE MEDIUM FOR DISPLAY PROCESSING PROGRAM

(71) Applicant: FUJITSU LIMITED, Kawasaki-shi (JP)

(72) Inventors: Hidehiko Mayumi, Kawasaki (JP); Toshio Tanaka, Yokohama (JP); Takeaki Kobayashi, Yokohama (JP); Kuniaki Ikematsu, Urayasu (JP)

(73) Assignee: FUJITSU LIMITED, Kawasaki-shi (JP)

(21) Appl. No.: 14/245,411

(22) Filed: Apr. 4, 2014

(30) Foreign Application Priority Data
May 21, 2013 (JP) 2013-107500

(51) Int. Cl. G06T 11/20

(52) U.S. Cl. CPC G06T 11/20
USPC 345/467

(57) ABSTRACT

A display processing apparatus includes a reception unit configured to receive registration of a symbol by associating the symbol with a plurality of data selected from a group of data when each data included in the group of data is disposed and displayed on a different area among display areas by a display device; and a display control unit configured to control the display device to display the symbol registered by being associated with the plurality of selected data, by associating the symbol with the designated data, when the designated data is included in the plurality of data, in a case where any one data included in the group of data is designated.

### CROSS-REFERENCE TO RELATED APPLICATION

This application is based upon and claims the benefit of priority from the prior Japanese Patent Application No. 2013-107500 filed on May 21, 2013, the entire content of which are incorporated herein by reference.

### FIELD

The present disclosure relates to a display processing apparatus, a system and a display processing program.

### BACKGROUND

Many classes are being conducted using mobile terminals, such as a slate terminal, in which a handwriting input is performed by a touch pen or finger, and it is anticipated that these type of classes will be more widely distributed.

There is a relevant technology in which an image display apparatus constituted by a display unit and a touch panel displays a plurality of corresponding images, along with an image surrounding the plurality of images, when the touch panel corresponding to the plurality of images displayed in the display unit is manipulated.

Further, there is a technology in which an area surrounded by a circular locus of bright spots of a pointer is displayed in an enlarged scale when an indication position of a pointer is moved by a user into a right direction to surround a portion of a screen-shaped projected image.

There is also a technology in which a projector generates a zoom image in which a portion of an image is highlighted and an area including the highlighted portion is enlarged, and projects the generated zoom image, based on indication information input by a user.

See, for example, Japanese Laid-Open Patent Publication No. 2010-113441, Japanese Laid-Open Patent Publication No. 2011-81651, and Japanese Laid-Open Patent Publication No. 2007-219217.

Following class type may be considered as the class type using the mobile terminal provided with a handwriting input function as described above. For example, an assignment is transmitted from a teacher's terminal to a student's terminal and an opinion regarding the assignment is input to the student's terminal by the student. Also, the student's terminal transmits the input opinion to the teacher's terminal. When the opinions transmitted from the student's terminals are integrated by a teacher, the teacher's terminal may display a plurality of integrated opinions in a matrix shape on an electronic blackboard connected to the teacher's terminal. Also, discussions regarding the opinions may be conducted by students while the plurality of opinions are being displayed on the electronic blackboard. Also, information on dividing the plurality of opinions displayed on the electronic blackboard into an approval group and a disapproval group is input by the teacher in handwriting, and such information is displayed to be overlapped on the plurality of opinions.

However, it is inconvenient to display the information on dividing opinions into groups to be overlapped on the plurality of opinions in the class type, as described above. For example, when the opinion designated by a teacher is displayed in an enlarged scale in conducting discussion between the students, only a portion displayed within an area of the designated opinion among the information on dividing opinions into groups is displayed. Accordingly, when the opinion designated by the teacher is displayed in an enlarged scale, the information on dividing opinions into groups may not be displayed. Therefore, a teacher or a student is not able to easily identify which group the opinion displayed in an enlarged scale belongs to. Accordingly, there is a problem in that convenience is low in the type of the class as described above in which information on dividing opinions into the groups is displayed by being overlapped on the plurality of opinions. Further, such a problem may similarly occur when displaying the designated data in a case where a symbol such as a figure associated with a plurality of data is displayed to be overlapped on the plurality of data.

One aspect of the present disclosure intends to enhance the convenience in displaying designated data.

### SUMMARY

According to one aspect of the embodiments, there is provided a display processing apparatus including a reception unit configured to receive registration of a symbol by associating the symbol with a plurality of data selected from a group of data when each data included in the group of data is disposed and displayed on a different area among display areas by a display device; and a display control unit configured to control the display device to display the symbol registered by being associated with the plurality of selected data, by associating the symbol with the designated data, when the designated data is included in the plurality of data, in a case where any one data included in the group of data is designated.

The object and advantages of the disclosure will be realized and attained by the elements and combinations particularly pointed out in the claims. It is to be understood that both the foregoing general descriptions and the following detailed descriptions are exemplary and explanatory, and are not restrictive of the invention, as claimed.

According to the present disclosure, it is possible to enhance convenience in displaying the designated data.

### BRIEF DESCRIPTION OF DRAWINGS

FIG. 1 is a view illustrating an exemplary configuration of a system according to an exemplary embodiment of the present disclosure.

FIG. 2 is a view illustrating an exemplary functional configuration of a teacher terminal.

FIG. 3 is a view illustrating an exemplary data structure of a student DB.

FIG. 4 is a view illustrating an exemplary data structure of an assignment DB.

FIG. 5 is a view illustrating an exemplary data structure of an assignment reply DB.

FIG. 6 is a view illustrating an exemplary data structure of a coordinate DB.

FIG. 7A is a view illustrating an exemplary data structure of a group-mark DB.

FIG. 7B is a view illustrating another exemplary data structure of a group-mark DB.

FIG. 8 is a view for explaining an example of an assignment selection screen generation method.

FIG. 9 is a view illustrating an example of a displayed content when a selection result, content of opinion and a family name of student are displayed on a display unit or an electronic blackboard in a matrix shape.

FIG. 10 is a view for explaining an example of a mark input in handwriting.

FIG. 11 is a view for explaining another example of a mark input in handwriting.

FIG. 12 is a view illustrating an example of a mark reception screen.

FIG. 13 is a view illustrating an example of an error screen.

FIG. 14 is a view illustrating an example of a screen in a case of displaying a designated opinion in an enlarged scale.

FIG. 15 is a view illustrating an example of a case where an opinion belonging to a plurality of groups exists among the plurality of opinions displayed in a matrix shape.

FIG. 16 is a view illustrating another example of a screen when the designated opinion is displayed in an enlarged scale.

FIG. 17 is a view illustrating another example of a screen when the designated opinion is displayed in an enlarged scale.

FIG. 18 is a view illustrating an exemplary functional configuration of a student terminal.

FIG. 19 is a view illustrating an exemplary reply screen.

FIG. 20A and FIG. 20B are flowcharts illustrating a sequence of a display control process according to the embodiment.

FIG. 21 is a flowchart illustrating a sequence of a mark reception process according to the embodiment.

FIG. 22 is a flowchart illustrating a sequence of an opinion display process according to the embodiment.

FIG. 23 is a view illustrating a computer that executes a display processing program.

### DESCRIPTION OF EMBODIMENTS

Hereinbelow, exemplary embodiments of a display processing apparatus, a system and a display processing program disclosed in the present disclosure will be described in detail with reference to drawings. Further, the embodiments are not intended to limit the disclosed technique.

### Embodiment

### Example of System Configuration

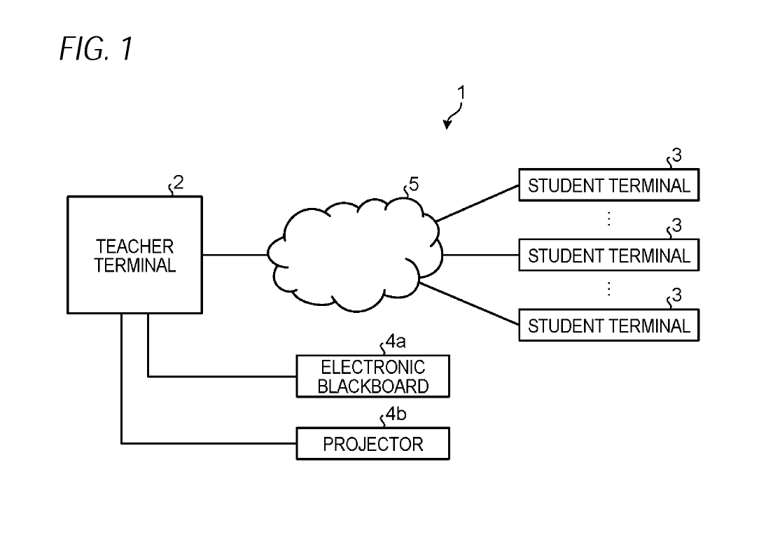

Descriptions will be made on a system according to an exemplary embodiment. FIG. 1 is a view illustrating an exemplary configuration of the system according to the embodiment. As illustrated in FIG. 1, the system 1 includes a teacher terminal 2, a plurality of student terminals 3, an electronic blackboard 4a and a projector 4b. The teacher terminal 2 and the plurality of student terminals 3 are connected with each other through, for example, a network 5. Accordingly, the teacher terminal 2 and the plurality of student terminals 3 may be communicated with each other. The network 5 may include any communication network such as the Internet, LAN (Local Area Network) or VPN (Virtual Local Network), irrespective of wired or wireless communication network.

The electronic blackboard 4a displays an image output from the projector 4b. The projector 4b controls the electronic blackboard 4a to display a predetermined image.

In the system 1 according to the embodiment, the teacher terminal 2 which is a terminal used by a teacher who conducts a class is manipulated to transmit an assignment to each of the plurality of student terminals 3 that correspond to the plurality of terminals used by each of a plurality of students who attend in the class conducted by the teacher. Then, the system 1 may be prompted such that the teacher terminal 2 transmits the assignment to the student terminal 3. Also, when an opinion about the assignment is input by the student, the student terminal 3 transmits the opinion input by the student to the teacher terminal 2 in the system 1. In the system 1, the teacher terminal 2 transmits opinions integrated by the teacher to the projector 4b or the student terminal 3 to display the opinions on the electronic blackboard 4a or the student terminal 3 in a matrix shape. By doing this, the teacher may conduct a class in which the students are requested to conduct discussions about the opinions while displaying the opinions on the electronic blackboard 4a or the student terminal 3.

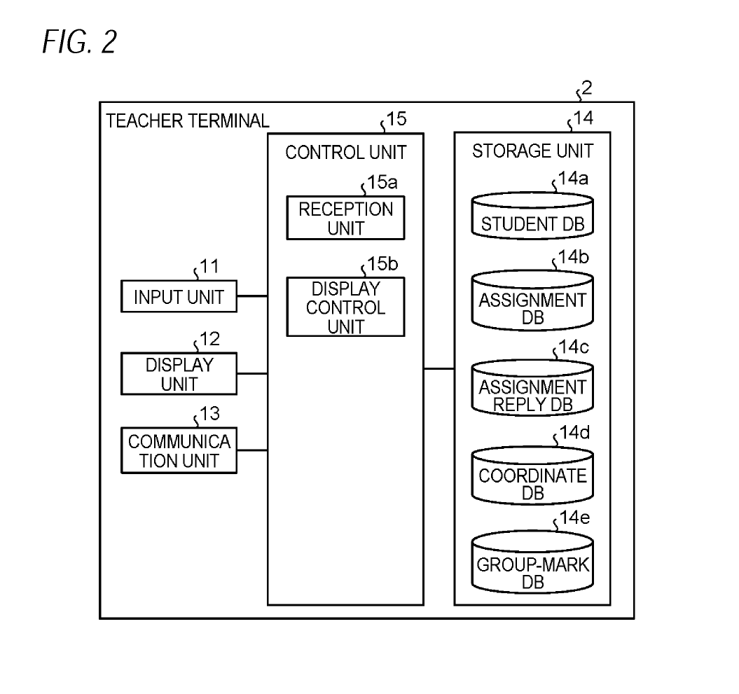

The teacher terminal 2 may be a variety of terminals including, for example, a mobile terminal such as a slate terminal. The teacher terminal 2 is an example of a display processing device. FIG. 2 is a view illustrating an exemplary functional configuration of the teacher terminal. As illustrated in the example of FIG. 2, the teacher terminal 2 includes an input unit 11, a display unit 12, a communication unit 13, a storage unit 14 and a control unit 15.

The input unit 11 inputs various information to the control unit 15. For example, the input unit 11 is a touch panel provided on the display unit 12, and receives input signal of a touch pen or a finger manipulated by the teacher who conducts the class and input the received signal to the control unit 15. An example of such manipulation of the touch pen or finger may include, for example drawing a mark to be described below or executing a display control process to be described below.

The display unit 12 displays various information. For example, the display unit 12 displays an assignment selection screen to be described below by the control of the reception unit 15a to be described below. Further, the display unit 12 displays an opinion of a student in an enlarged scale by the control of the display control unit 15b. An example of a device of the display unit 12 may include, for example, a liquid crystal display.

The communication unit 13 is a communication interface for allowing the teacher terminal 2, the student terminal 3, the electronic blackboard 4a and the projector 4b to communicate with each other.

The storage unit 14 stores various information. For example, the storage unit 14 stores a student database 14a, an assignment database 14b, an assignment reply database 14c, a coordinate database 14d and a group-mark database 14e. Hereinbelow, a database is abbreviated to “DB”.

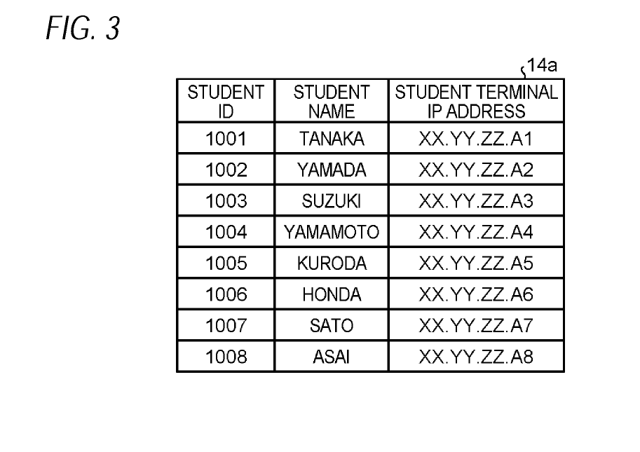

Various information of students who attend in a class are registered in the student DB 14a. FIG. 3 is a view illustrating an exemplary data structure of a student DB. As illustrated in the example of FIG. 3, the student DB 14a includes fields for a “student ID”, a “student name” and a “student terminal IP (Internet Protocol) address”. An ID for identifying a student is registered in the “student ID” field in advance. A family name of a student identified by the ID registered in the “student ID” field is registered in the “student name” field in advance. An IP address of the student terminal 3 used by the student identified by the ID registered in the “student ID” field is registered in the “student terminal IP address” field.

For example, a first record of the student DB 14a illustrated in the example of FIG. 3 indicates that the family name identified by the ID “1001” is “Tanaka” and the IP address of the student terminal 3 used by the student “Tanaka” is “XX.YY.ZZ.A1”. The same rule applies with other records of the student DB 14a.

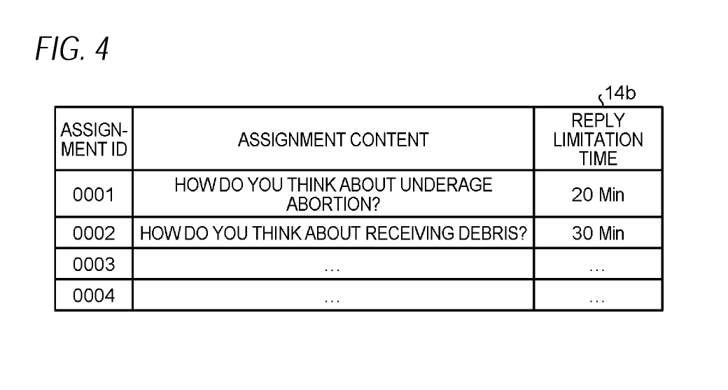

Information on an assignment presented by a teacher to a student is registered in the assignment DB 14b. FIG. 4 is a view illustrating an exemplary data structure of an assignment DB. As illustrated in an example of FIG. 4, an assignment DB 14b includes fields for an “assignment ID”, an “assignment content” and a “reply limitation time”. An ID for identifying an assignment is registered in the “assignment ID” field in advance. The content of assignment identified by the ID registered in the “assignment ID” field are registered in the “assignment content” field in advance. The limitation time indicating a time until a reply is received from a student after an assignment identified by the ID registered in the “assignment ID” field is presented to the student is registered in the “reply limitation time” field in advance.

For example, a first record of the student DB 14a illustrated in the example of FIG. 4 indicates that the content of assignment identified by the ID “0001” is “How do you think about underage abortion?”. Additionally, the first record of the student DB 14a illustrated in the example of FIG. 4 indicates that a time (limitation time) until a reply is received from a student after an assignment identified by the ID “0001” is presented to the student is “20 minutes”. The same rule applies with other records of the student DB 14b.

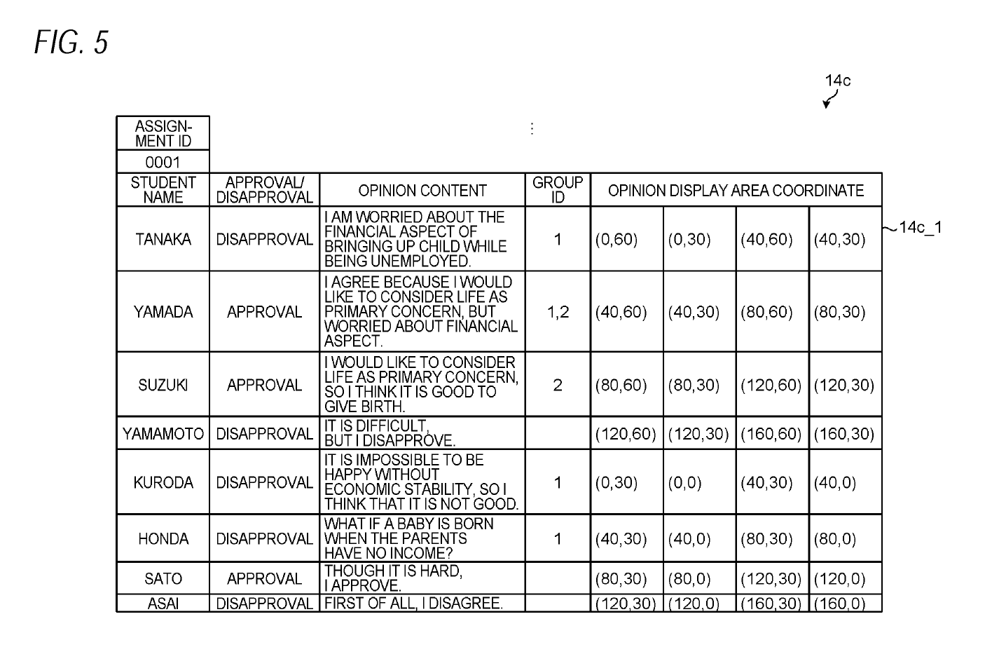

The assignment reply DB 14c includes a table in which various information on the reply of student about an assignment for each assignment are registered. FIG. 5 is a view illustrating an exemplary data structure of an assignment reply DB. As illustrated in an example of FIG. 5, the assignment reply DB 14c includes a table 14c_1 in which the reply of student about the assignment for each assignment is registered. The table 14c_1 includes fields for an “assignment ID”, a “student name”, an “approval/disapproval”, an “opinion content”, a “group ID”, an “opinion display area coordinate”. An ID for identifying an assignment is registered in the “assignment ID” field by the reception unit 15a to be described below. A family name of a student who replies an opinion about the assignment identified by the ID registered in the “assignment ID” field is registered in the “student name” field by the reception unit 15a. The content of approval or disapproval replied by the student having a family name registered in the “student name” field is registered in an “approval/disapproval” field by the reception unit 15a, as an approval or disapproval about the same assignment. The content of opinion replied by the student having a family name registered in the “student name” field is registered in an “opinion content” field by the reception unit 15a, as an opinion content of the same assignment.

In a case where a plurality of opinions are displayed in a matrix shape to be described below, the coordinates of four corners of an area in which an opinion of the student having a family name registered in the “student name” field is displayed are registered in the “opinion display area coordinate” by the reception unit 15a. That is, the coordinate of the left upper position, the coordinate of the left lower position, the coordinate of the right upper position, the coordinate of the right lower position of the area in which the opinion is displayed are registered in the “opinion display area coordinate” field by the reception unit 15a.

For example, the table 14c_1 illustrated in an example of FIG. 5 indicates a table in which the reply of the student about the assignment about “How do you think about underage abortion?” identified by the ID “0001” is registered. Further, a first record of the table 14c_1 illustrated in the example of FIG. 5 indicates that the student having the family name of “Tanaka” has an opinion of “disapproval” about “underage abortion” about the assignment of “How do you think about underage abortion?”. Further, the first record of the table 14c_1 illustrated in the example of FIG. 5 indicates that the student having the family name of “Tanaka” has replied an opinion content of “i am worried about bringing up child when being unemployed because of the financial aspect” about the assignment of “How do you think about underage abortion?”. Furthermore, the first record of the table 14c_1 illustrated in the example of FIG. 5 indicates that the coordinate of the left upper position is (0, 60), the coordinate of the left lower position is (0, 30), the coordinate of the right upper position is (40, 60), and the coordinate of the right lower position is (40, 30) of an area in which an opinion replied by the student having the family name of “Tanaka” is displayed. The same rule applies with other records of the table 14c_1.

The electronic pen is manipulated on the electronic blackboard 4a by the teacher and thus, various information of a mark drawn on the electronic blackboard 4a is registered in the coordinate DB 14d. Further, the touch pen or finger is manipulated on the input unit 11 by the teacher and thus, various information of a mark drawn on the display unit 12 is registered in the coordinate DB 14d. That is, various information of a mark input in handwriting by the teacher are registered in the coordinate DB 14d. Here, the mark is also referred to as a symbol. The mark may be various shapes such as a character, a sign, and a figure.

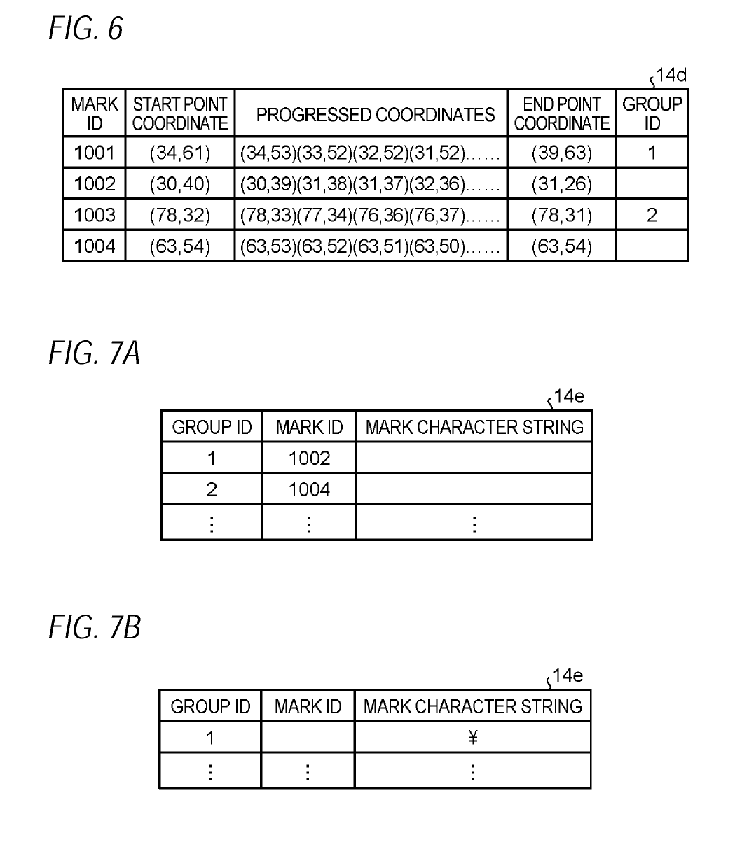

FIG. 6 is a view illustrating an exemplary data structure of the coordinate DB. As illustrated in an example of FIG. 6, the coordinate DB 14d includes fields for a “mark ID”, a “start point coordinate”, a “progressed coordinate”, an “end point coordinate” and a “group ID”.

An ID for identifying a mark is registered in the “mark ID” field by the reception unit 15a. A start point coordinate of the mark identified by the ID registered in the “mark ID” field is registered in the “start point coordinate” field by the reception unit 15a to be described below. The coordinates of points between the start point coordinate and the end point coordinate of the mark identified by the ID registered in the in the “mark ID” field are registered in the “progressed coordinate” field by the reception unit 15a. An end point coordinate of the mark identified by the ID registered in the “mark ID” field is registered in the “end point coordinate” field by the reception unit 15a. Further, coordinates of points of between the start point coordinate and the end point coordinate of the mark are referred to as progressed coordinates. An ID for identifying a group to which the mark identified by the ID registered in the “mark ID” field belongs is registered in the “group ID” field by the reception unit 15a.

For example, the first record of the coordinate DB 14d illustrated in the example of FIG. 6 indicates that a coordinate of a start point is (34, 61), the progressed coordinates are (34, 53), (33, 52), (32, 52), (31, 52) . . . , and a coordinate of an end point of a mark identified by the ID “1001” is (39, 63). Further, the first record of the coordinate DB 14d illustrated in the example of FIG. 6 indicates that the mark identified by the ID “1001” belongs to a group identified by an ID “1”.

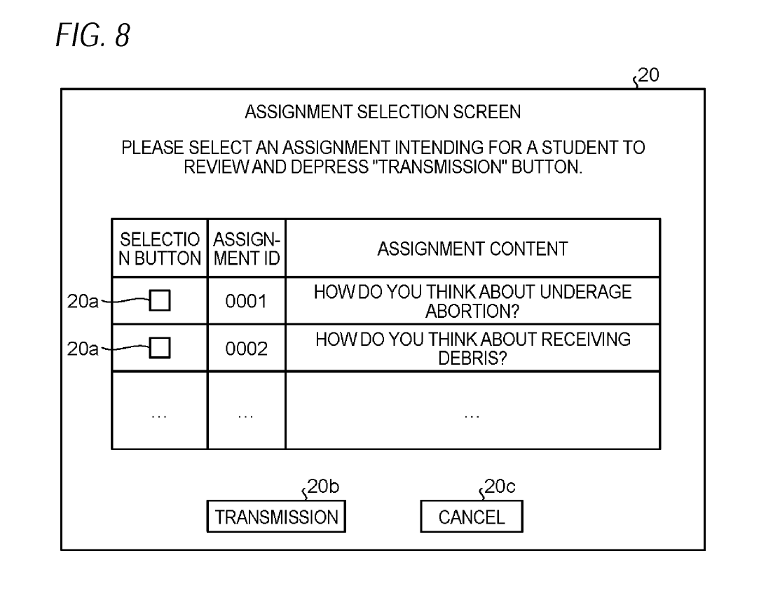

Information on the mark and a group ID to which the mark belongs are registered in the group-mark DB 14e by being associated with each other by the reception unit 15a. FIG. 7A and FIG. 7B are views illustrating exemplary data structures of a group-mark DB. The group-mark DB 14e illustrated in examples of FIG. 7A and FIG. 7B includes fields for a “group ID”, a “mark ID”, and a “mark character string”. An ID for identifying the mark is registered in the “mark ID” field by the reception unit 15a. A character string of the mark input in a mark reception screen is registered in the “mark character string” field by the reception unit 15a. An ID of a group to which the mark identified by the ID registered in the “mark ID” field belongs or an ID of a group to which the mark indicated by the character string registered in the “mark character string” field belongs is registered in the “group ID” filed by the reception unit 15a.

For example, a first record of the group-mark DB 14e illustrated in an example of FIG. 7A indicates that the mark identified by ID “1002” belongs to a group identified by ID “1”. Further, the first record of the group-mark DB 14e illustrated in an example of FIG. 7B indicates that the mark identified by a character string “¥” belongs to a group identified by the ID “1”.

The storage unit 14 may be a storage device including, for example, a semiconductor memory device such as a flash memory, or a hard disk or an optical disk.

The control unit 15 includes an internal memory for storing a program in which various processing sequences are defined or a control data, and executes various processes by the program and the control data. As illustrated in FIG. 2, the control unit 15 includes the reception unit 15a and the display control unit 15b.

When each opinion included in a group of opinions is disposed and displayed on a different area among display areas in the display unit 12 or the electronic blackboard 4a, the reception unit 15a receives registration of a mark by associating the mark with a plurality of opinions selected among the group of opinions. One aspect of the reception unit 15a will be described. For example, when an instruction to execute a display control process is input from the input unit 11 due to the manipulation of the touch pen or finger by the teacher, the reception unit 15a generates an assignment selection screen and controls the display unit 12 to display the assignment selection screen.

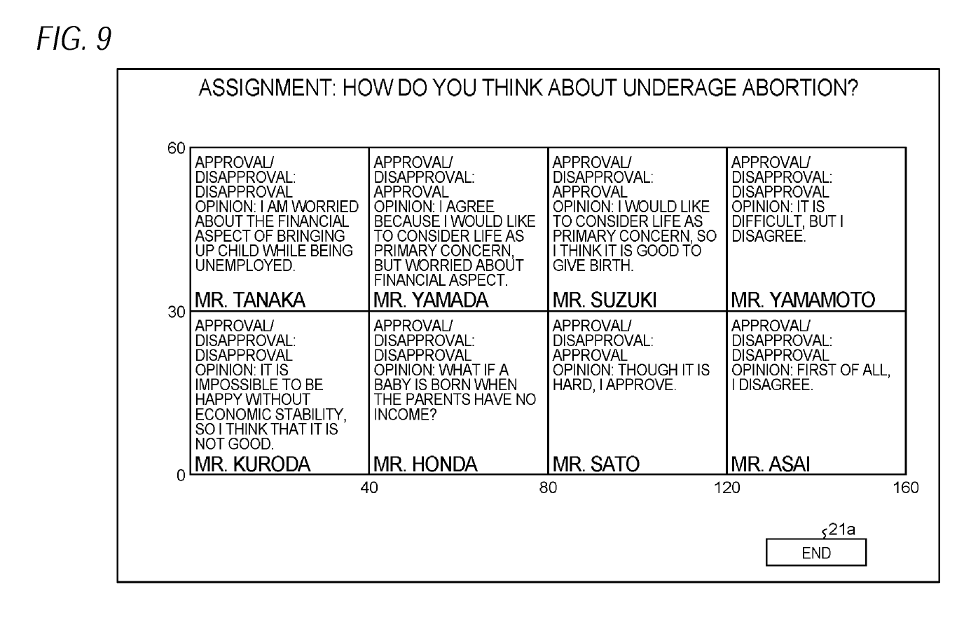

An example of an assignment selection screen generation method by the reception unit 15a will be described. FIG. 8 is a view explaining an example of an assignment selection screen generation method. When generating an assignment selection screen, the reception unit 15a first acquires all of the IDs and the contents of the assignments registered in the assignment DB 14b. The reception unit 15a, as illustrated in an example of FIG. 8, registers the acquired ID and the content of the assignments in the “assignment ID” field and the “assignment content” of the assignment selection screen 20 by associating the ID of the assignments with the contents of the assignments, respectively. Further, as illustrated in the example of FIG. 8, the reception unit 15a prepares a check box 20a in a “selection button” field of the assignment selection screen 20 by associating the check box 20a with the “assignment ID” field and the “assignment content” field. The teacher manipulates the input unit 11 using the touch pen or finger to check the check box 20a. For example, when the check box 20a associated with a first record of the assignment selection screen 20 illustrated in the example of FIG. 8 is checked, the checked check box 20a indicates the following matters. That is, the check box 20a indicates that an assignment of which content is “How do you think about underage abortion?” is selected as the assignment identified by the ID “0001”. Further, as illustrated in an example of FIG. 8, the reception unit 15a prepares a button 20b for acquiring the ID and the content of the assignment associated with the checked check box in the assignment selection screen 20. Further, the reception unit 15a prepares a button 20c for closing the assignment selection screen 20 in the assignment selection screen 20. Further, the reception unit 15a, as illustrated in the example of FIG. 8, prepares a message, which is used for urging the teacher to select the assignment, of “Please select an assignment intending for a student to review and depress ‘Transmission’ button.” in the assignment selection screen 20. The reception unit 15a generates the assignment selection screen 20 according to the method described above. Also, the reception unit 15a controls the display unit 12 to display the assignment selection screen 20. By doing this, the display unit 12 displays the assignment selection screen 20.

The reception unit 15a determines whether the ID and the content of the assignment associated with the checked check box 20a are received after controlling the display unit 12 to display the assignment selection screen 20. For example, the reception unit 15a determines whether the ID and the content of the assignment associated with the checked check box 20a are acquired as a result of the depression of the button 20b to determine whether the and the content of the assignment are received.

When the ID and the content of the assignment are received, the reception unit 15a transmits the received ID and the content of the assignment to the student terminal 3 through the network 5 using an IP address registered in the student DB 14a. Then, as will be described below, a selection result of approval or disapproval about the transmitted content of the assignment, an opinion about the content of the assignment, and a student ID are transmitted from the student terminal 3 to the teacher terminal 2 through the network 5. By doing this, the reception unit 15a may receive the opinion of the student or the selection result of approval or disapproval from the student terminal 3. Further, though not illustrated, the student ID may be input by the student at the time of logging-in the student terminal.

Also, the reception unit 15a acquires a limitation time associated with the received ID of the assignment from the assignment DB 14b. Subsequently, the reception unit 15a receives the selection result of approval or disapproval, the opinion about the content of the assignment, and the student ID from the student terminal 3 during a time period until the acquired limitation time elapses after transmitting the ID and the content of the assignment to the student terminal 3. When the selection result of approval or disapproval, the opinion about the content of the assignment, and the student ID are received, the reception unit 15a performs the following process. That is, the reception unit 15a specifies a table 14c_1 in which the received ID of the assignment is registered in the “assignment ID” field among the plurality of tables 14c_1 of the assignment reply DB 14c. The reception unit 15a acquires the family name of the student associated with the student ID received from the student DB 14a. The reception unit 15a adds a new record in the table 14c_1, registers the acquired family name of student in the “student name” field, registers the received selection result of approval or disapproval in the “approval/disapproval” field and registers the received opinion in the “opinion content” field of the added record.

Also, the reception unit 15a registers each of the coordinates of upper left, lower left, upper right and lower right of the four corners of the area in which the opinion registered in the “opinion content” field is displayed in the “opinion display area coordinate” field of the added record. Further, the reception unit 15a generates the coordinates of the four corners of the area in which the opinion registered is displayed such that the received plurality of opinions are displayed in a matrix shape, and registers the generated coordinates in the added record.

By performing the processes described above, the reception unit 15a registers the following data in the specified table 14c_1 together with the selection result of approval or disapproval and the opinion about the content of the assignment received during a time period until the acquired limitation time elapses. That is, the reception unit 15a registers the family name of student and the coordinates of the four corners of the area in which the opinion is displayed in the specified table 14c_1 together with the selection result and the opinion.

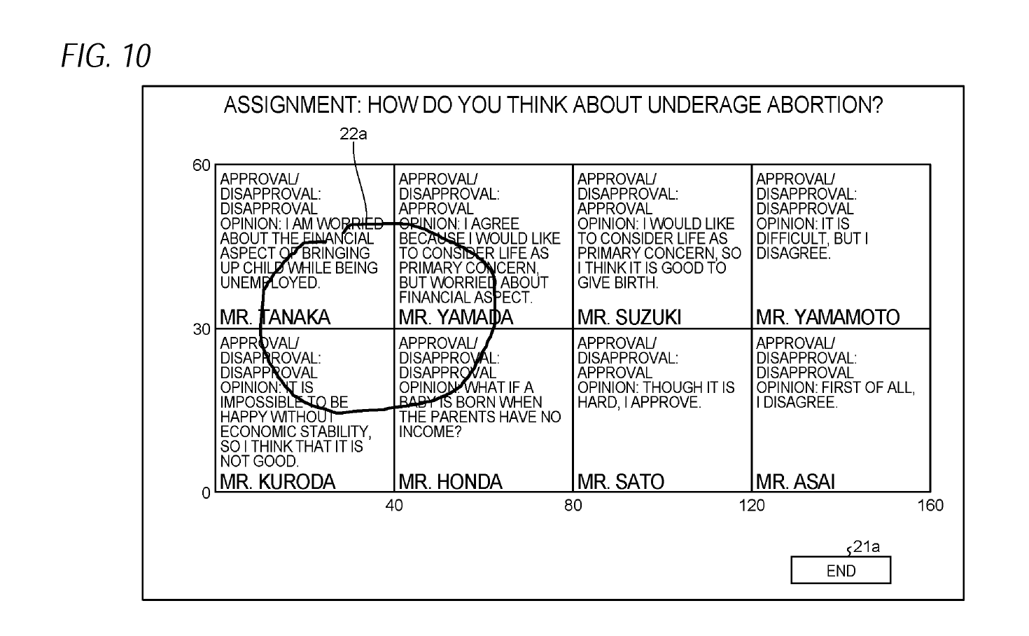

When the limitation time elapses, the reception unit 15a controls the projector 4b to display the selection result of approval or disapproval, and the opinion on the electronic blackboard 4a in a matrix shape. Further, the reception unit 15a controls the display unit 12 to display the selection result of approval or disapproval and the opinion in a matrix shape. An example of process performed by the reception unit 15a to control the display unit 12 and the projector 4b to display the selection result of approval or disapproval and the opinion in a matrix shape will be described. For example, the reception unit 15a acquires registered contents of the “student name” field, the “approval/disapproval” field, the “opinion content” field and the “opinion display area coordinate” field of all the records of the specified table 14c_1. Also, the reception unit 15a controls the display unit 12 and the projector 4b to integrate and display the selection result registered in the “approval/disapproval” field, the content of the opinion registered in the “opinion content” field, and the family name registered in the “student name” field with respect to each of all the records. That is, the reception unit 15a controls the display unit 12 and the projector 4b to display the selection result, the content of the opinion, and the family name of student in the area specified by coordinates of the four corners registered in the “opinion display area coordinate” field. The processes described above are performed by the reception unit 15a and thus, the selection result, the content of opinion and the family name of student are associated with one another and displayed in a matrix shape in the display unit 12 and the electronic blackboard 4a. FIG. 9 is a view illustrating an example of displayed content when a selection result, a content of opinion and a family name of student are displayed on a display unit or an electronic blackboard in a matrix shape. For example, when the registered content of the “student name” field, the “approval/disapproval” field, the “opinion content” field and the “opinion display area coordinate” field of all the records of the table 14c_1 as illustrated in the example of FIG. 5 are acquired, the reception unit 15a controls the projector 4b to display the content as indicated in the example of FIG. 9 on the electronic blackboard 4a. Additionally, the reception unit 15a controls the display unit 12 to display the content as indicated in the example of FIG. 9. Here, each number of “40”, “80”, “120” and “160” arranged in a horizontal direction indicates that the X-coordinate from the origin of coordinate “0” in the example of FIG. 9. Further, each number of “30” and “60” arranged in a vertical direction indicates that the Y-coordinate from the origin of coordinate “0” in the example of FIG. 9. Further, the button 21a is a button to end the display control process.

The example of FIG. 9 represents a case where the selection result “disapproval” of the student “Tanaka” is displayed in an area specified by coordinates of the four corners (e.g., upper left coordinate (0, 60), lower left coordinate (0, 30), upper right coordinate (40, 60), lower right coordinate (40, 30)). Further, the example of FIG. 9 represents a case where the opinion “i am worried about bringing up child when being unemployed because of the financial aspect.” of the student “Tanaka” is displayed in an area specified by coordinates of the four corners (e.g., upper left coordinate (0, 60), lower left coordinate (0, 30), upper right coordinate (40, 60), lower right coordinate (40, 30)). The same rule applies with opinions of other students.

Further, the reception unit 15a may transmit an instruction to display the selection result of approval or disapproval and the opinion that are received in a matrix shape to the student terminal 3. By doing this, the screen containing the content as illustrated in the example of FIG. 9 is displayed.

When the opinions are displayed on the display unit 12 or the electronic blackboard 4a in a matrix shape, the reception unit 15a determines whether a mark input in handwriting by the manipulation of the electronic pen by the teacher exists on the opinions displayed on the electronic blackboard 4a. Further, the reception unit 15a determines whether a mark input in handwriting by the manipulation of the touch pen or finger by the teacher exists based on the input result from the input unit 11 which is the touch panel provided on the display unit 12.

When it is determined that the mark input in handwriting exists, the reception unit 15a controls the projector 4b to display the mark input in handwriting on the opinions displayed on the electronic blackboard 4a in a matrix shape. Further, the reception unit 15a controls the display unit 12 to display the mark input in handwriting on the opinions displayed in a matrix shape. By the processes described above, the mark input in handwriting is displayed on the opinions displayed on the electronic blackboard 4a or the display unit 12.

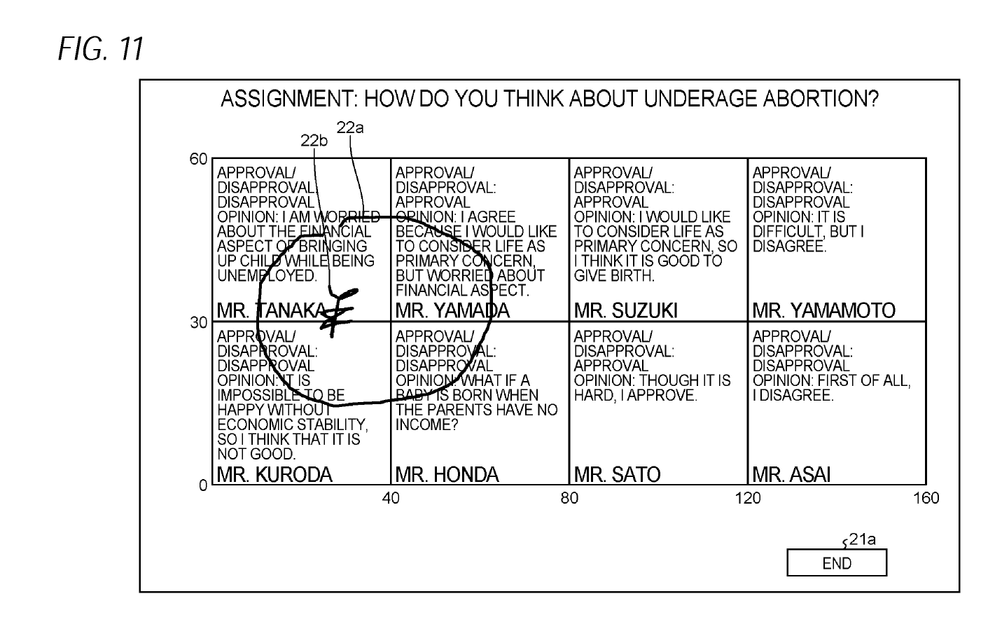

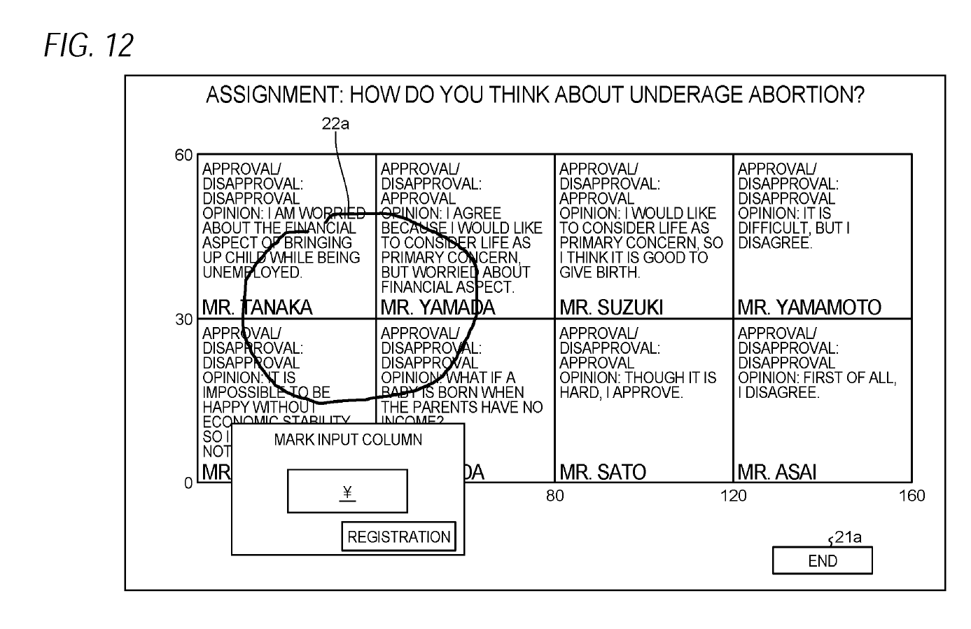

FIG. 10 and FIG. 11 are views explaining examples of a mark input in handwriting. The example of FIG. 10 indicates an example of the mark displayed on the opinions displayed in a matrix shape indicated in the example of FIG. 9. The example of FIG. 10 indicates a case where a mark 22a having substantially a circular shape and associates a plurality of opinions replied by the students “Kuroda”, “Tanaka”, “Yamada” and “Honda” who describe their opinions from an economical point of view is input in handwriting.

Further, the example of FIG. 11 indicates a case where a mark 22b is newly input in handwriting after the mark 22a having substantially the circular shape displayed on the opinion displayed in a matrix shape indicated in the example of FIG. 10 is input in handwriting. The mark 22b is a mark of a symbol “¥” indicating that the opinions associated by the mark 22a having substantially the circular shape are opinions described based on from the economical point of view. In the example of FIG. 11, the entire mark 22b is included within an area surrounded by a line of the mark 22a having substantially the circular shape and associating the plurality of opinions replied by the students “Kuroda”, “Tanaka”, “Yamada” and “Honda”. In this case, the mark 22b belongs to the same group as a group to which the mark 22a belongs.

The reception unit 15a controls the projector 4b to display the mark input in handwriting on the opinions displayed on the electronic blackboard 4a and controls the display unit 12 to display the mark input in handwriting on the opinions and then, performs the following process. That is, the reception unit 15a acquires the coordinate of the start point and the coordinate of the end point of the mark input in handwriting every one stroke of a unicursal curve. Further, the reception unit 15a acquires the coordinate of points between the start point and the end point of the mark along the mark at regular intervals. Further, the reception unit 15a generates an ID of a new mark not registered in the coordinate DB 14d.

Also, the reception unit 15a adds the new record in the coordinate DB 14d and registers the generated ID of the mark in the “mark ID” field of the added record. The reception unit 15a registers the coordinate of the start point, the coordinates of the points between the start point and the end point and the coordinate of the end point of the mark input in handwriting in the “start point coordinate” field, the “progressed coordinate” field and the “end point coordinate” field of the added record, respectively. By doing this, the ID of mark, the coordinate of the start point, the progressed coordinates and the coordinate of the end point are registered in the coordinate DB 14d.

Subsequently, the reception unit 15a determines whether a new mark is surrounded by the line of the mark of which the ID, the coordinate of the start point, the progressed coordinates and the coordinate of the end point are registered in the coordinate DB 14d before a new mark of which the ID, the coordinate of the start point, the progressed coordinates and the coordinate of the end point are newly registered in the coordinate DB 14d. For example, the reception unit 15a acquires the ID, the coordinate of the start point, the progressed coordinates and the coordinate of the end point with respect to all the marks of which the ID, the coordinate of the start point, the progressed coordinates and the coordinate of the end point are registered in the coordinate DB 14d before the new mark. Also, the reception unit 15a determines whether the entire area of the new mark surrounded by the line connecting the coordinate of the start point, the progressed coordinates and the coordinate of the end point of the new mark is included within the area surrounded by the line connecting the coordinate of the start point, the progressed coordinates and the coordinate of the end point with respect to each of all the marks of which ID, the coordinate of the start point, the progressed coordinates and the coordinate of the end point are acquired. By doing this, the reception unit 15a may determine whether the new mark is surrounded by the line of each mark of which the ID, the coordinate of the start point, the progressed coordinates and the coordinate of the end point are registered in the coordinate DB 14d before the new mark.

Here, when it is determined that a mark which includes the entire coordinate of the new mark within the area does not exist among the marks of which the ID, the coordinate of the start point, the progressed coordinates and the coordinate of the end point are registered in the coordinate DB 14d before the new mark, the reception unit 15a determines whether the line of the new mark covers a plurality of areas in which the opinions are displayed. For example, when the mark 22a illustrated in an example of FIG. 10 is input in handwriting, the reception unit 15a determines that the line of the new mark 22a covers four areas, each of which displays the opinion of each of four students “Tanaka”, “Yamada”, “Honda” and “Kuroda”.

When it is determined that the line of the new mark covers the plurality of areas in which the opinions are displayed, the reception unit 15a specifies a record that the coordinates of four corners in the area are registered in the “opinion display area coordinate” field among all the records of the specified table 14c_1 with respect to all the areas covered by the line of the new mark. Further, the reception unit 15a specifies a record that the coordinates of four corners in the area are registered in the “opinion display area coordinate” field among all the records of the specified table 14c_1 with respect to all the areas surrounded by the line of the new mark among the areas in which the opinions are displayed.

For example, in the example illustrated in FIG. 10, the reception unit 15a specifies a first record that the coordinates of four corners of the area in which the opinion of the student “Tanaka” covered by the line of the new mark 22a is displayed are registered in the “opinion display area coordinate” field, among all the records of the specified table 14c_1 illustrated in the example of FIG. 5. Further, the reception unit 15a specifies a second record that the coordinates of four corners of the area in which the opinion of the student “Yamada” covered by the line of the new mark 22a is displayed are registered in the “opinion display area coordinate” field, among all the records of the specified table 14c_1 illustrated in the example of FIG. 5. Further, the reception unit 15a specifies a sixth record that the coordinates of four corners of the area in which the opinion of the student “Honda” covered by the line of the new mark 22a is displayed are registered in the “opinion display area coordinate” field, among all the records of the specified table 14c_1 illustrated in the example of FIG. 5. Further, the reception unit 15a specifies a fifth record that the coordinates of four corners of the area in which the opinion of the student “Kuroda” covered by the line of the new mark 22a is displayed are registered in the “opinion display area coordinate” field, among all the records of the specified table 14c_1 illustrated in the example of FIG. 5. Accordingly, in the example illustrated FIG. 10, the reception unit 15a specifies four records corresponding to the first record, the second record, the fifth record and the sixth among all the records of the specified table 14c_1 illustrated in the example of FIG. 5.

Also, the reception unit 15a generates an ID of a group which is not registered in the “group ID” fields of all the tables 14c_1 of the assignment reply DB 14c, and registers the generated ID of the group in the “group ID” fields of all the specified records. For example, the reception unit 15a generates a group ID of “1” which is not registered in the “group ID” of all the tables 14c_1, and registers the generated group ID of “1” in the “group ID” field of all the specified records, as illustrated in the example of FIG. 5.

Also, the reception unit 15a specifies a record that a new ID of a mark is registered in the “mark ID” field among all the records of the coordinate DB 14d and registers the ID of the group which is newly generated in the “group ID” field of the specified record. For example, when the new ID of the mark is “1001” and the newly generated ID of the group is “1”, the reception unit 15a performs the following process. That is, the reception unit 15a registers the ID of the group “1” which is newly generated in the “group ID” field of the first record of the coordinate DB 14d, as illustrated in the example of FIG. 6.

In the meantime, when it is determined that all the coordinates of the new mark are included within an area surrounded by a line connecting the coordinate of the start point, the progressed coordinates and the coordinate of the end point of any mark among all the marks of which the ID, the coordinate of the start point, the progressed coordinates and the coordinate of the end point are registered in the coordinate DB 14d before the new mark, the reception unit 15a performs the following process. That is, the reception unit 15a specifies a mark which includes all the coordinate of the new mark within the area surrounded by the line connecting the coordinate of the start point, the progressed coordinates and the coordinate of the end point. Also, the reception unit 15a determines whether the ID of the group is registered in the coordinate DB 14d by being associated with the specified ID of the mark.

Here, when it is determined that the ID of the group is not registered in the coordinate DB 14d by being associated with the specified ID of the mark, the reception unit 15a performs the following process. That is, the reception unit 15a performs the process described above which determines whether the line of the new mark covers the plurality of areas in which the opinions are displayed. Also, when it is determined that the line of the new mark covers the plurality of areas in which the opinions are displayed, the reception unit 15a performs the process described above in which a record that the coordinates of four corners of the area are registered in “opinion display area coordinate” field with respect to all the areas covered by the line of the new mark is specified among all the records of the specified table 14c_1. Further, the reception unit 15a also performs the process described above in which a record that the coordinates of four corners of the area are registered in “opinion display area coordinate” field is specified among all the records of the specified table 14c_1 similarly with respect to all the areas surrounded by the line of the new mark. Also, the reception unit 15a performs the process described above which generates an ID of the group which is not registered in the “group ID” field of all the tables 14c_1, and registers the generated ID of the group in the “group ID” field of all the specified records. Also, the reception unit 15a performs the process described above which specifies a record that a new ID of a mark is registered in the “mark ID” field among all the records of the coordinate DB 14d, and registers the ID of the group which is newly generated in the “group ID” field of the specified record.

In the meantime, when it is determined that the ID of the group is registered in the coordinate DB 14d by being associated with the specified ID of the mark, the reception unit 15a specifies a record that the ID of the group registered in the coordinate DB 14d by being associated with the specified ID of the mark is registered in the “group ID” field among all the records of the group-mark DB 14e. Also, the reception unit 15a registers the new ID of the mark in the “mark ID” field of the specified record. By doing this, the reception unit 15a may associate the ID of the group registered in the coordinate DB 14d by being associated with the specified ID of mark with the new ID of the mark to be registered in the group-mark DB 14e.

For example, when the ID of the new mark 22b is “1002”, the ID of the specified mark 22a is “1001” and the ID of the group registered in the coordinate DB 14d by being associated with the ID of the mark “1001” is “1”, the reception unit 15a associates the new ID of the mark 22b “1002” with the ID of the group “1” to be registered in the group-mark DB 14e, as indicated in the first record of the group-mark DB 14e illustrated in the example of FIG. 7.

Further, the reception unit 15a determines whether an instruction to execute a mark reception process is input due to the manipulation of the electronic pen by the teacher in any one area in which any one opinion among the opinions displayed in the electronic blackboard 4a in a matrix shape is displayed. Further, the reception unit 15a determines whether an instruction to execute a mark reception process is input due to the manipulation of the touch pen or finger by the teacher in any one area in which any one opinion among the opinions displayed on the display unit 12 in a matrix shape is displayed.

When it is determined that the instruction to execute the mark reception process is input, the reception unit 15a executes the mark reception process.

In the mark reception process, the reception unit 15a determines whether the ID of the group is registered in the assignment reply DB 14c by being associated with a family name of a student who has replied the opinion displayed in the area in which the instruction to execute the mark reception process is input. For example, in the example illustrated in FIG. 10, when the family name of the student is “Honda”, the reception unit 15a determines whether the ID of the group is registered in the assignment reply DB 14c by being associated with the family name of student “Honda”.

When it is determined that whether the ID of the group is registered in the assignment reply DB 14c by being associated with the family name of the student who has replied the opinion displayed in the area in which the instruction to execute the mark reception process is input, the reception unit 15a controls the projector 4b to display a mark reception screen for receiving a mark on the electronic blackboard 4a. Further, the reception unit 15a controls the display unit 12 to display the mark reception screen. By doing this, the mark reception screen is displayed on the electronic blackboard 4a or the display unit 12. The mark reception screen includes an area in which a character and a character string indicating the mark is input and a button (registration button) for registering the character or the character string indicating the mark input into the area in the group-mark DB 14e.

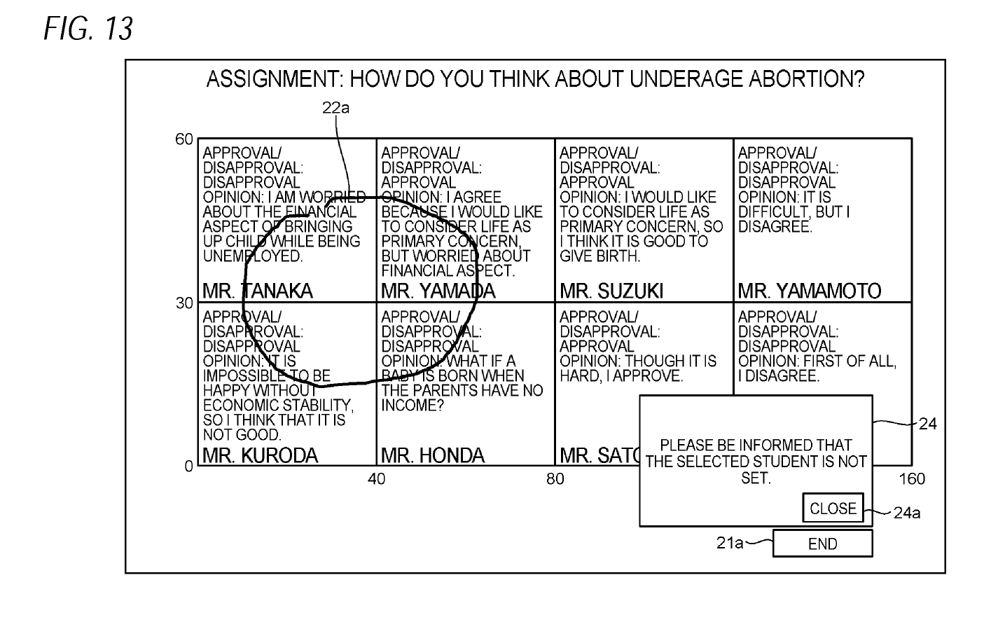

FIG. 12 is a view illustrating an example of a mark reception screen. The mark reception screen 23 illustrated in an example of FIG. 12 indicate an example of the mark reception screen displayed by the reception unit 15a when it is determined that the ID of group “1” is registered in the assignment reply DB 14c by being associated with the family name of student “Honda” in the example illustrated in FIG. 10. The mark reception screen includes a button (registration button) 23b for registering an area 23a in which a character and a character string indicating the mark is input and a button (registration button) 23b for registering the character or the character string indicating the mark input into the area 23a in the group-mark DB 14e.

Also, the reception unit 15a determines whether the character or the character string indicating the mark is input, due to the manipulation of the electronic pen by the teacher, to the area described above of the mark reception screen displayed on the electronic blackboard 4a. Further, the reception unit 15a determines whether the character or the character string indicating the mark is input, due to the manipulation of the touch pen or finger by the teacher, to the area described above of the mark reception screen displayed on the display unit 12.

When it is determined that the character or the character string indicating the mark is input, the reception unit 15a controls the projector 4b to display the character or the character string indicating the input mark on the area of the mark reception screen displayed on the electronic blackboard 4a. Further, the reception unit 15a controls the display unit 12 to display the character or the character string indicating the input mark on the area of the mark reception screen. For example, when the character “ø” indicating the mark is input, the reception unit 15a controls the projector 4b or the display unit 12 to display the character “¥” indicating the mark is displayed on the area 23a, as illustrated in an example of FIG. 12.

Also, the reception unit 15a determines whether the registration button of the mark reception screen displayed on the electronic blackboard 4a is depressed due to the manipulation of the electronic pen by the teacher. Further, the reception unit 15a determines whether the registration button of the mark reception screen displayed on the display unit 12 is depressed due to the manipulation of the touch pen or finger by the teacher.

When it is determined that the registration button is depressed, the reception unit 15a performs the following process. That is, the reception unit 15a specifies the ID of the group registered in the assignment reply DB 14c by being associated with a family name of student who has replied the opinion displayed on the area in which the instruction to execute the mark reception process is input. Also, the reception unit 15a specifies a record that the specified ID of the group is registered in the “group ID” field among all the records of the group-mark DB 14e. Also, the reception unit 15a registers the character or the character string of the mark displayed on the area described above of the mark reception screen in the “mark character string” field of the specified record. By doing this, the specified ID of the group and the character or the character string of the mark on displayed on the area described above of the mark reception screen are associated with each other to be registered in the group-mark DB 14e. For example, as indicated by the first record of the group-mark DB 14e of FIG. 7B, the reception unit 15a associates the specified ID of the group “1” with the character “¥” of the mark displayed on the area 23a of the mark reception screen 23 to be registered in the group-mark DB 14e.

Also, the reception unit 15a closes the mark reception screen and ends the mark reception process.

Further, when it is determined that the ID of the group is not registered in the assignment reply DB 14c by being associated with a family name of student who has replied the opinion displayed on the area in which the instruction to execute the mark reception process, the reception unit 15a controls the projector 4b to display an error screen indicating that the group is not set in relation to the student on the electronic blackboard 4a. Further, the reception unit 15a controls the display unit 12 to display the error screen. By doing this, the error screen is displayed on the electronic blackboard 4a or the display unit 12. An error screen 24 includes a message indicating that the group is not set in relation to the student and a button for closing the error screen.

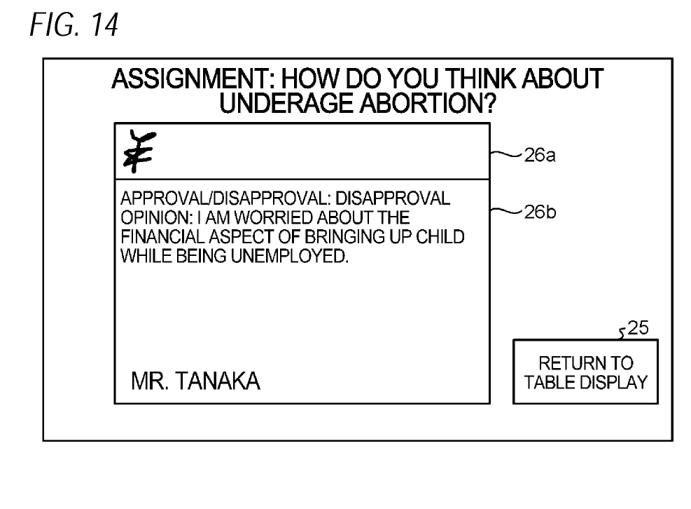

FIG. 13 is a view illustrating an example of an error screen. The error screen 24 illustrated in an example of FIG. 4 includes a message of “Please be informed that a group for the selected student is not set” and a button 24a for closing the error screen 24. Specifically, when an instruction to execute the mark reception process is input in an area of the student “Asai” displayed on the lower right portion of FIG. 13, the opinion of the “Asai” is not set in any group and thus, the error screen 24 is displayed as illustrated in FIG. 13.

Also, the reception unit 15a determines whether the button for closing the error screen displayed on the electronic blackboard 4a is depressed due to the manipulation of the electronic pen by the teacher. Further, the reception unit 15a determines whether the button for closing the error screen displayed on the display unit 12 is depressed due to the manipulation of the touch pen or finger by the teacher.

When it is determined that the button for closing the error screen is depressed, the reception unit 15a closes the error screen and ends the mark reception process.

Further, the reception unit 15a determines whether the button to end a display control process is depressed due to the manipulation of the electronic pen by the teacher when the opinions are displayed on the electronic blackboard 4a in a matrix shape. Further, the reception unit 15a determines whether the button to end the display control process is depressed due to the manipulation of the touch pen or finger by the teacher when the opinions are display on the display unit 12 in a matrix shape.

When it is determined that the button to end the display control process is depressed, the reception unit 15a ends the display control process.

Referring back to the description of FIG. 2, in a case where any one opinion included in the group of opinions is designated by the teacher, the display control unit 15b performs the following process when the designated opinion is included in a plurality of opinions selected from the group of opinions. That is, the display control unit 15b controls the projector 4b to display the mark registered by being associated with the plurality of selected opinions on the electronic blackboard 4a, together with the designated opinion. Further, the display control unit 15b controls the display unit 12 to display the mark registered by being associated with the plurality of selected opinions, together with the designated opinion.

One aspect of the display control unit 15b will be described. For example, the display control unit 15b determines whether an opinion to be displayed in an enlarged scale is designated from the opinions displayed on the electronic blackboard 4a in a matrix shape using the electronic pen by the teacher. Further, the display control unit 15b determines whether an opinion to be displayed in an enlarged scale is designated from the opinions displayed on the display unit 12 in a matrix shape using the touch or the finger by the teacher.

When it is determined that the opinion to be displayed in an enlarged scale is designated, the display control unit 15b executes an opinion display process.

In the opinion display process, the display control unit 15b determines whether the ID of the group is registered in the assignment reply DB 14c by being associated with the content of the designated opinion.

When it is determined that the ID of the group is registered in the assignment reply DB 14c by being associated with the content of the designated opinion, the display control unit 15b determines whether any one of the ID of the mark and the character or character string of the mark is registered in the group-mark DB 14e by being associated with the ID of the group determined as registered in the assignment reply DB 14c.

When it is determined that any one the ID of the mark and the character or character string of the mark is registered in the group-mark DB 14e by being associated with the ID of the group determined as registered in the assignment reply DB 14c, the display control unit 15b determines whether the ID of the mark exists among data determined as registered in the group-mark DB 14e.

When it is determined that the ID of mark exists among the data determined as registered in the group-mark DB 14e, the display control unit 15b acquires the coordinate of the start point, the progressed coordinates and the coordinate of the end point associated with the ID of the mark from the coordinate DB 14d with respect to each of all the IDs of the marks determined as registered in the group-mark DB 14e. Also, the display control unit 15b generates an image of the mark indicated by the acquired coordinate of the start point, progressed coordinates and coordinate of the end point on a work area of the internal memory of the control unit 15 using the acquired coordinate of the start point, progressed coordinates and coordinate of the end point with respect to each of all the IDs of the marks determined as registered in the group-mark DB 14e. Accordingly, in the present embodiment, each time when the opinion is displayed in an enlarged scale, the image of the mark is generated using the coordinate of the start point, the progressed coordinates and the coordinate of the end point and thus, it is possible to suppress the reduction of a capacity of the storage unit 14 which is capable of being used for storing as compared to a case where the image of mark is stored in the storage unit 14 in advance.

Also, the display control unit 15b reduces the generated image with respect to each of all the generated images of the marks at a predetermined reduction ratio. Subsequently, the display control unit 15b controls the projector 4b or the display unit 12 to display all the images reduced at a predetermined reduction ratio on a mark display area, which will be describe below, included in a screen when the designated opinion is displayed in an enlarged scale. Accordingly, the entire mark that is information on dividing into groups is displayed when the designated opinion is displayed in an enlarged scale by the teacher, according to the present embodiment. Therefore, the teacher or the student may easily identify which group the opinion displayed in an enlarged scale belongs to. Accordingly, according to the present embodiment, a convenience in displaying the designated opinion may be increased.

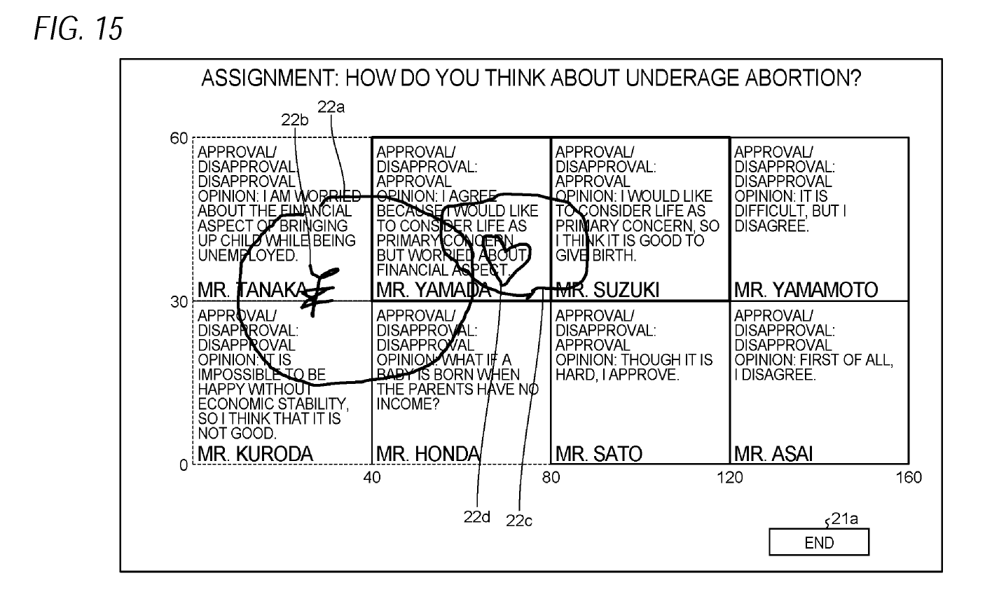

When the designated opinion is displayed on a screen in an enlarged scale, the screen includes a mark display area in which the mark indicating a group to which the designated opinion belongs is displayed and an opinion display area in which the designated opinion is displayed in an enlarged scale. Further, when the designated opinion is displayed on the screen in an enlarged scale, the screen includes a button to return to a previous screen in which the designated opinion was not displayed in an enlarged scale, that is, a previous screen in which the opinion is displayed in a matrix shape. FIG. 14 is a view illustrating an example of a screen when a designated opinion is displayed on the screen in an enlarged scale. An example of FIG. 14 illustrates an exemplary screen in which the opinion of the student “Tanaka” is displayed in an enlarged scale when the opinion of the student “Tanaka” is designated by the teacher in the example illustrated in FIG. 11. As illustrated in an example of FIG. 14, the screen in which the designated opinion is displayed in an enlarged scale includes a mark display area 26a in which the mark indicating a group to which the designated opinion belongs is displayed and an opinion display area 26b in which the designated opinion is displayed in an enlarged scale. Further, as illustrated in an example of FIG. 14, the screen in which the designated opinion is displayed in an enlarged scale includes a button 25 to return to a previous screen in which the designated opinion was not displayed in an enlarged scale, that is, a previous screen in which the opinion is displayed in a matrix shape.

In the example illustrated in FIG. 11, when the opinion of the student “Tanaka” is designated by the teacher, the display control unit 15b acquires the coordinate of the start point, the progressed coordinates and the coordinate of the end point of the mark 22b from the coordinate DB 14d, and generates the image of the mark 22b using the acquired coordinate of the start point, progressed coordinates and coordinate of the end point. Also, the display control unit 15b reduces the generated image of the mark 22b at a predetermined reduction ratio, and controls the projector 4b or the display unit 12 to display the reduced image, as illustrated in the example of FIG. 14. Further, nothing is displayed in the opinion display area 26b at the time when the display control unit 15b controls the projector 4b or the display unit 12 to display the reduced image on the mark display area 26a.

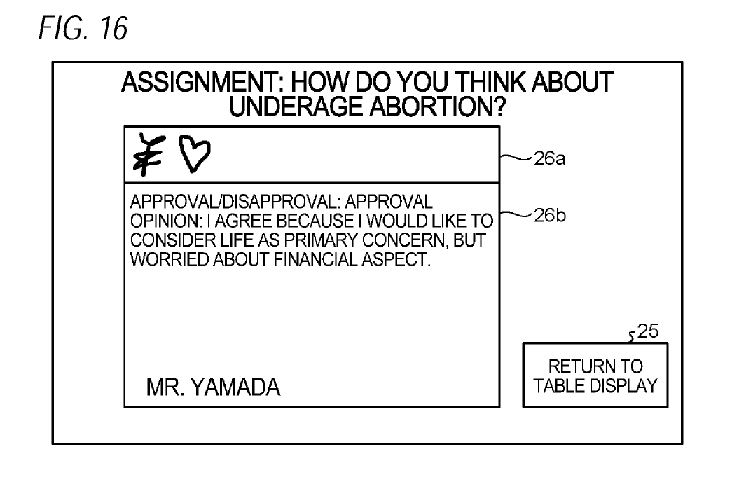

FIG. 15 is a view illustrating an example of a case where an opinion belonging to a plurality of groups exists among the plurality of opinions displayed in a matrix shape. In the screen illustrated in an example of FIG. 4, the entirety of a mark 22b is included in an area surrounded by a line of a mark 22a and the entirety of a mark 22d is included in an area surrounded by a line of a mark 22c. Further, in the example of FIG. 15, the mark 22c has substantially the circular shape and associates two opinions replied by the students “Yamada” and “Suzuki” who describe their opinion from a point of view that life is precious.

Further, in the example of FIG. 15, the mark 22d has a heart shape and indicates that two opinions associated with each other by the mark 22c having substantially the circular shape are opinions described from a point of view that life is precious. In the example of FIG. 15, as described above, the entire mark 22d is included in an area surrounded by the line of the mark 22c having substantially the circular shape and associating two opinions replied by the students “Yamada” and “Suzuki” with each other. In this case, the mark 22d belongs to the same group as a group to which the mark 22c belongs.

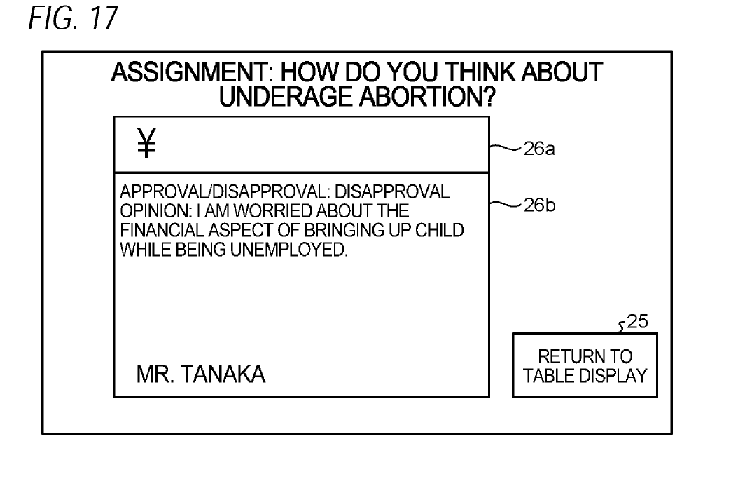

Further, in the example of FIG. 15, the opinion of the student “Yamada” belongs to two groups of one group to which the mark 22b belongs and the other group to which the mark 22d belongs. Therefore, in the example illustrated in FIG. 15, when the opinion of the student “Yamada” is designated by the teacher, the display control unit 15b acquires the coordinate of the start point, the progressed coordinates and the coordinate of the end point of the mark 22b and the coordinate of the start point, the progressed coordinates and the coordinate of the end point of the mark 22d from the coordinate DB 14d. Also, the display control unit 15b generates the image of the mark 22b and the image of the mark 22d using each of the acquired coordinates of the start points, progressed coordinates and coordinates of the end points. Also, the display control unit 15b reduces the generated image of the mark 22b and the image of the mark 22d at a predetermined reduction ratio. Also, the display control unit 15b controls the projector 4b or the display unit 12 to display the reduced image of the mark 22b and image of the mark 22d on the mark display area 26a as illustrated in an example of FIG. 16. Further, FIG. 16 is a view illustrating another example of a screen when the designated opinion is displayed on the screen in an enlarged scale. Further, nothing is displayed in the opinion display area 26b at the time when the display control unit 15b controls the projector 4b or the display unit 12 to display the reduced image on the mark display area 26a.

Also, the display control unit 15b determines whether the character or character string of the mark exists among the data determined as registered in the group-mark DB 14e.

When it is determined that the character or character string of the mark exists among the data determined as registered in the group-mark DB 14e, the display control unit 15b acquires each of all the characters or character strings of the marks from the group-mark DB 14e. Subsequently, the display control unit 15b controls the projector 4b or the display unit 12 to display all the acquired characters or character strings of the marks from the group-mark DB 14e on the mark display area included in the screen when the designated opinion is displayed on the screen in an enlarged scale. Accordingly, the entirety of the mark that is information on dividing into groups is displayed when the designated opinion is displayed in an enlarged scale by the teacher, according to the present embodiment. Therefore, the teacher or the student may easily identify which group the opinion displayed in an enlarged scale belongs to. Accordingly, a convenience in displaying the designated opinion may be increased according to the present embodiment.

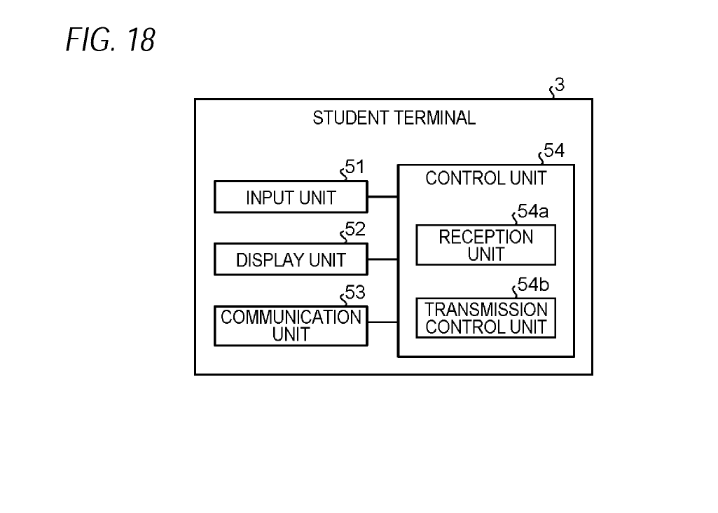

FIG. 17 is a view illustrating another example of a screen when the designated opinion is displayed in an enlarged scale. The example of FIG. 17 illustrates an example of the screen when the opinion of the student “Tanaka” is displayed in an enlarged scale when the opinion of the student “Tanaka” is designated by the teacher in the example illustrated in FIG. 12.

When the opinion of the student “Tanaka” is designated by the teacher in the example illustrated in FIG. 12, the display control unit 15b acquires the character “¥” of the mark determined as registered in the group-mark DB 14e from the group-mark DB 14e. Also, the display control unit 15b controls the projector 4b or the display nit 12 to display the character “¥” of the mark acquired from the group-mark DB 14e on the mark display area 26a, as illustrated in the example of FIG. 17. Further, nothing is displayed in the opinion display area 26b at the time when the display control unit 15b controls the projector 4b or the display unit 12 to display the acquired character “¥” of the mark on the mark display area 26a.

Also, the display control unit 15b acquires the content of the designated opinion from the assignment reply DB 14c. Further, the display control unit 15b acquires the family name of student and the content of approval or disapproval that are registered by being associated with the content of the designated opinion from the assignment reply DB 14c.

Also, the display control unit 15b controls the projector 4b or the display unit 12 to display the acquired content of approval or disapproval, content of the opinion, and family name of student on the opinion display area in an enlarged scale. For example, the display control unit 15b controls the projector 4b or the display unit 12 to display the content of approval or disapproval, content of the opinion, and family name of student on the opinion display area 26b in an enlarged scale as illustrated in FIG. 14, FIG. 16 and FIG. 17.

Also, the display control unit 15b determines whether the button for returning to the screen in which the opinions are displayed in a matrix shape is depressed due to the manipulation of the electronic pen by the teacher. Further, the display control unit 15b determines whether the button for returning to the screen in which the opinion is displayed in a matrix shape is depressed due to the manipulation of the touch pen or finger by the teacher.

When it is determined that the button for returning to the screen in which the opinions are displayed in a matrix shape is depressed, the display control unit 15b acquires the registered contents of the “student name” field, the “approval/disapproval” field, the “opinion content” field and the “opinion display area coordinate” field of all the records of the specified table 14c_1. Also, the display control unit 15b controls the projector 4b or the display unit 12 to display the screen in which the opinions are displayed in a matrix shape using the acquired registered contents. Further, the display control unit 15b acquires the coordinate of the start point, the progressed coordinates and the coordinate of the end point registered in the “start point coordinate” field, the “progressed coordinate” field and the “end point coordinate” field of all the records of the coordinate DB 14d, and controls the projector 4b or the display unit 12 to display each mark based on the acquired coordinate of the start point, progressed coordinates and coordinate of the end point on the opinion. Also, the display control unit 15b ends the opinion display process.

The control unit 15 is a circuit such as the ASIC (Application Specific Integrated Circuit), FPGA (Field Programmable Gate Array), CPU (Central Processing Unit) or MPU (Micro Processing Unit).

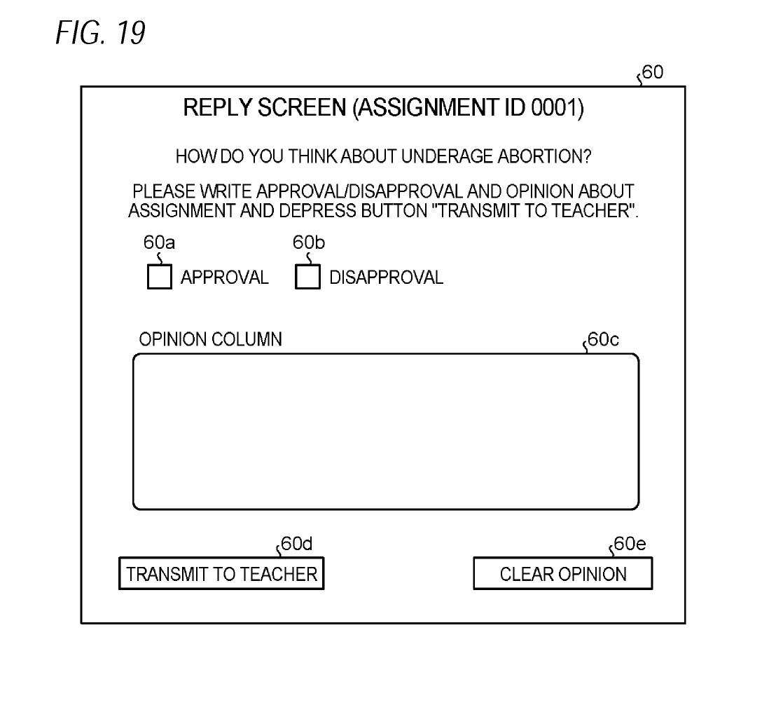

Referring back to the description of FIG. 1, the student terminal 3 may be a variety of terminals including, for example, a mobile terminal, such as a slate terminal, in which a handwriting input is allowed. The student terminal 3 is used by a student who attends in class. FIG. 18 is a view illustrating an exemplary functional configuration of a student terminal. As illustrated in an example of FIG. 18, the student terminal 3 includes an input unit 51, a display unit 52, a communication unit 53 and a control unit 54.

The input unit 51 inputs various information to the control unit 54. For example, the input unit 51 is a touch panel provided on the display unit 52, and receives manipulation of the touch pen or finger used by student who attends in class and inputs the received manipulation to the control unit 54.

The display unit 52 displays various information. For example, the display unit 52 displays a reply screen to be described below by the control of the reception unit 54a. An example of the display unit 52 may include, for example, a liquid crystal display.

The communication unit 53 may be a communication interface for allowing the student terminal 3 and the teacher terminal 2 to communicate with each other.

The control unit 54 includes an internal memory for storing a program defining various processing sequences or a control data, and executes various processes by the program and the control data. As illustrated in FIG. 18, the control unit 54 includes a reception unit 54a and a transmission control unit 54b.

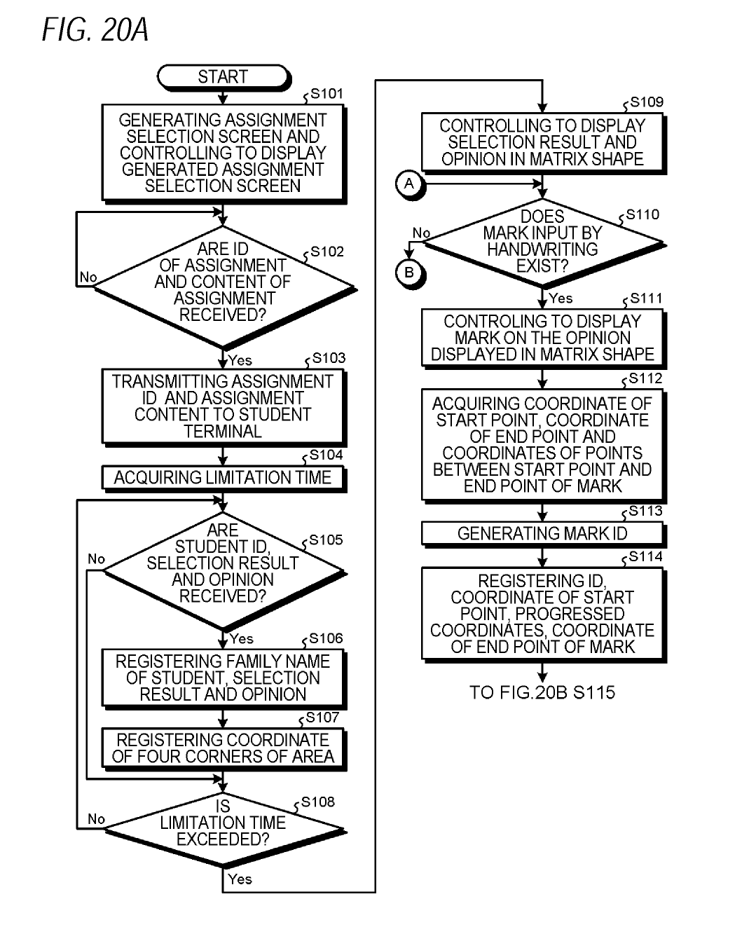

When the ID and the content of the assignment transmitted from the teacher terminal 2 are received, the reception unit 54a generates the reply screen 60 as illustrated in an example of FIG. 19 using the ID and the content of the assignment. FIG. 19 is a view illustrating an exemplary reply screen. When the student has an opinion of approval for an assignment, the check box 60a illustrated in the example of FIG. 19 is checked due to the manipulation of the input unit 51 by the student. Further, when the student has an opinion of disapproval for the assignment, the check box 60b illustrated in the example of FIG. 19 is checked due to the manipulation of the input unit 51 by the student. The opinion for the assignment is input to a text box 60c illustrated in the example of FIG. 19 due to the manipulation of the input unit 51 by the student. The button 60d illustrated in the example of FIG. 19 is a button for transmitting check results of the check boxes 60a and 60b and the opinion input to the text box 60c to the teacher terminal 2. When the button 60d is depressed, the check results of the check boxes 60a and 60b and the opinion input to the text box 60c are transmitted to the teacher terminal 2 through the communication unit 53 by a transmission control unit 54b to be described below. The button 60e illustrated in the example of FIG. 19 is a button for clearing the check results of the check boxes 60a and 60b and the opinion input to the text box 60c. When the button 60e is depressed, the check results of the check boxes 60a and 60b and the opinion input to the text box 60c are cleared.

When the button 60d is depressed due to the manipulation of the input unit 51 by the student, the transmission control unit 54b transmits the check results of the check boxes 60a and 60b and the opinion input to the text box 60c to the teacher terminal 2 through the communication unit 53.

The control unit 54 is a circuit such as the ASIC, FPGA, CPU or MPU.

[Flow of Process]

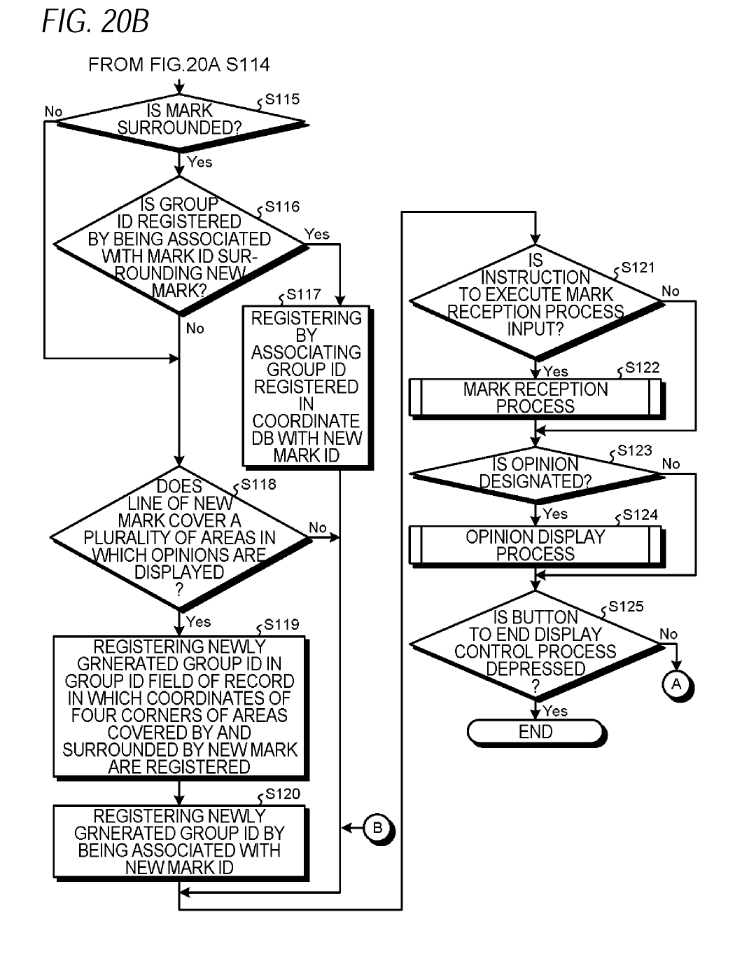

Next, a flow of process executed by the teacher terminal 2 according to the present embodiment will be described. FIG. 20A and FIG. 20B are flowcharts illustrating a sequence of a display control process according to the embodiment. For example, when an instruction to execute the display control process is input to the control unit 15 from the input unit 11, the display control process according to the embodiment is executed by the control unit 15.

As illustrated in FIG. 20A and FIG. 20B, the reception unit 15a generates an assignment selection screen and controls the display unit 12 to display the generated assignment selection screen (S101).

The reception unit 15a determines whether the ID and the content of the assignment associated with the checked check box 20a is received (S102). When it is determined that the ID and the content of the assignment are not received (“NO” at step S102), the reception unit 15a performs the process of step S102 again.

In the meantime, when it is determined that the ID and the content of the assignment are received (“YES” at step S102), the reception unit 15a transmits the received ID and the content of the assignment to the student terminal 3 through the network 5 using an IP address registered in the student DB 14a (S103).

Also, the reception unit 15a acquires the limitation time associated with the received ID of the assignment from the assignment DB 14b (S104). Subsequently, the reception unit 15a determines whether the selection result of approval or disapproval, the opinion about the content of the assignment, and the student ID are received from the student terminal 3 (S105). When it is determined that the selection result of approval or disapproval, the opinion about the content of the assignment, and the student ID are not received (“NO” at step S105), the reception unit 15a proceeds to step S108 to be described below. In the meantime, when it is determined that the selection result of approval or disapproval, the opinion about the content of the assignment, and the student ID are received (“YES” at step S105), the reception unit 15a specifies the table 14c_1 in which the received ID of the assignment is registered in the “assignment ID” field among a plurality of the tables 14c_1 of the assignment reply DB 14c. Also, the reception unit 15a adds a new record in the specified table 14c_1 and acquires a family name of a student associated with the student ID from the student DB 14a. Also, the reception unit 15a registers the acquired family name of the student in the “student name” field of the added record, registers the selection result of approval or disapproval in the “approval/disapproval” field of the added record, and registers the received opinion in the “opinion content” field of the added record (S106).

Also, the reception unit 15a registers each of the coordinates of upper left, lower left, upper right, lower right of the four corners of the area in which the opinion registered in the “opinion content” field is displayed in the “opinion display area coordinate” field of the added record (S107).

The reception unit 15a determines whether a time after transmitting the ID and the content of the assignment to the student terminal 3 exceeds the limitation time (S108). When it is determined that the time does not exceed the limitation time (“NO” at step S108), the reception unit 15a goes back to step S105.

In the meantime, when it is determined that the time exceeds the limitation time (“YES” at step S108), the reception unit 15a acquires the received selection results of approval or disapproval and the opinion from the assignment reply DB 14c, and controls the projector 4b to display the acquired selection results of approval or disapproval and the opinion on the electronic blackboard 4a in a matrix shape. Further, the reception unit 15a acquires the received selection results of approval or disapproval and the opinion from the assignment reply DB 14c, and controls the display unit 12 to display the acquired selection results of approval or disapproval and the opinion in a matrix shape. Further, the reception unit 15a may transmit an instruction to display the received selection results of approval or disapproval and the opinion in a matrix shape to the student terminal 3 (S109).

The reception unit 15a determines whether a mark input in handwriting due to the manipulation of the electronic pen by the teacher exists on the opinion displayed on the electronic blackboard 4a. Further, the reception unit 15a determines whether the mark input in handwriting due to the manipulation of the touch pen or finger by the teacher exists based on the input result from the input unit 11 which is the touch panel provided on the display unit 12 (S110). As such, it is determined whether the mark input in handwriting exists in one of the electronic blackboard 4a and the display unit 12. When it is determined that the mark input in handwriting does not exist (“NO” at step S110), the reception unit 15a proceeds to step S121 to be described below.

In the meantime, when it is determined that the mark input in handwriting exists (“YES” at step S110), the reception unit 15a controls the projector 4b to display the mark input in handwriting on the opinion displayed on the electronic blackboard 4a in a matrix shape. Further, the reception unit 15a controls the display unit 12 to display the mark input in handwriting on the opinion displayed in a matrix shape (S111).

Also the reception unit 15a acquires the coordinate of the start point and the coordinate of the end point of the mark input in handwriting every one stroke. Further, the reception unit 15a acquires coordinate of points between the start point and the end point of the mark along the mark at regular intervals. (S112). Furthermore, the reception unit 15a generates an ID of a new mark not registered in the coordinate DB 14d (S113).

Also, the reception unit 15a adds the new record in the coordinate DB 14d and registers the generated ID of the mark in the “mark ID” field of the added record. Also, the reception unit 15a registers the coordinate of the start point, the coordinate of the points between the start point and the end point and the coordinate of the end point of the mark input in handwriting in the “start point coordinate” field, the “progressed coordinate” field and the “end point coordinate” field of the added record, respectively (S114).

Subsequently, the reception unit 15a determines whether a new mark is surrounded by the line of the mark of which the ID, the coordinate of the start point, the progressed coordinates and the coordinate of the end point are registered in the coordinate DB 14d, before the mark (new mark) of which the ID, the coordinate of the start point, the progressed coordinates and the coordinate of the end point are newly registered in the coordinate DB 14d (S115).

Here, when it is determined that a mark which includes all the coordinates of the new mark within the area does not exist among the marks of which the IDs, the coordinates of the start points, the progressed coordinates and the coordinates of the end points are registered in the coordinate DB 14d before the new mark does not exist (“NO” at step S115), the reception unit 15a determines whether the line of the new mark covers a plurality of areas in which the opinions are displayed (S118). When it is determined that the line of the new mark does not cover the plurality of areas in which the opinions are displayed (“NO” at step S118), the reception unit 15a proceeds to step S121.

In the meantime, when it is determined that the line of the new mark covers the plurality of in which the opinions are displayed (“YES” at step S118), the reception unit 15a specifies a record associated with all the areas covered by the line of the new mark among all the records of the specified table 14c_1. Further, the reception unit 15a specifies a record associated with all the areas surrounded by the line of the new mark among the areas in which the opinions are displayed, among all the records of the specified table 14c_1. Also, the reception unit 15a generates an ID of a group which is not registered in the “group ID” fields of all the tables 14c_1 of the assignment reply DB 14c and registers the generated ID of the group in the “group ID” fields of all the specified records (S119).

Also, the reception unit 15a specifies a record that a new ID of a mark is registered in the “mark ID” field among all the records of the coordinate DB 14d and registers the ID of the group which is newly generated in the “group ID” field of the specified record (S120). Also, the reception unit 15a proceeds to step S121.

Here, when it is determined that all the coordinate of the new mark are included within an area surrounded by a line connecting the coordinate of the start point, the progressed coordinates and the coordinate of the end point of any mark (“YES” at step S115), the reception unit 15a specifies the mark which includes all the coordinate of the new mark within the area surrounded by the line connecting the coordinate of the start point, the progressed coordinates and the coordinate of the end point. Also, the reception unit 15a determines whether the ID of the group is registered in the coordinate DB 14d by being associated with the specified ID of mark (S116).

When it is determined that the ID of the group is not registered in the coordinate DB 14d by being associated with the specified ID of the mark (“NO” at step S116), the reception unit 15a proceeds to step S118.

In the meantime, when it is determined that the ID of the group is registered in the coordinate DB 14d by being associated with the specified ID of the mark (“YES” at step S116), the reception unit 15a specifies a record that the ID of the group is registered in the coordinate DB 14d by being associated with the specified ID of the mark is registered in the “group ID” field, among all the records of the group-mark DB 14e. Also, the reception unit 15a registers the new ID of the mark in the “mark ID” field of the specified record (S117).

Also, the reception unit 15a determines whether an instruction to execute a mark reception process is input in any one area in which any one opinion among the opinions displayed in the electronic blackboard 4a is displayed in a matrix shape, due to the manipulation of the electronic pen by the teacher. Further, the reception unit 15a determines whether an instruction to execute a mark reception process is input due to the manipulation of the touch pen or finger by the teacher in any one area in which any one opinion among the opinions displayed on the display unit 12 is displayed in a matrix shape (S121). When it is determined that the instruction to execute the mark reception process is not input (“NO” at step S121), the reception unit 15a proceeds to step S123 to be described below.

In the meantime, when it is determined that the instruction to execute the mark reception process is input (“YES” at step S121), the reception unit 15a executes the mark reception process (S122).

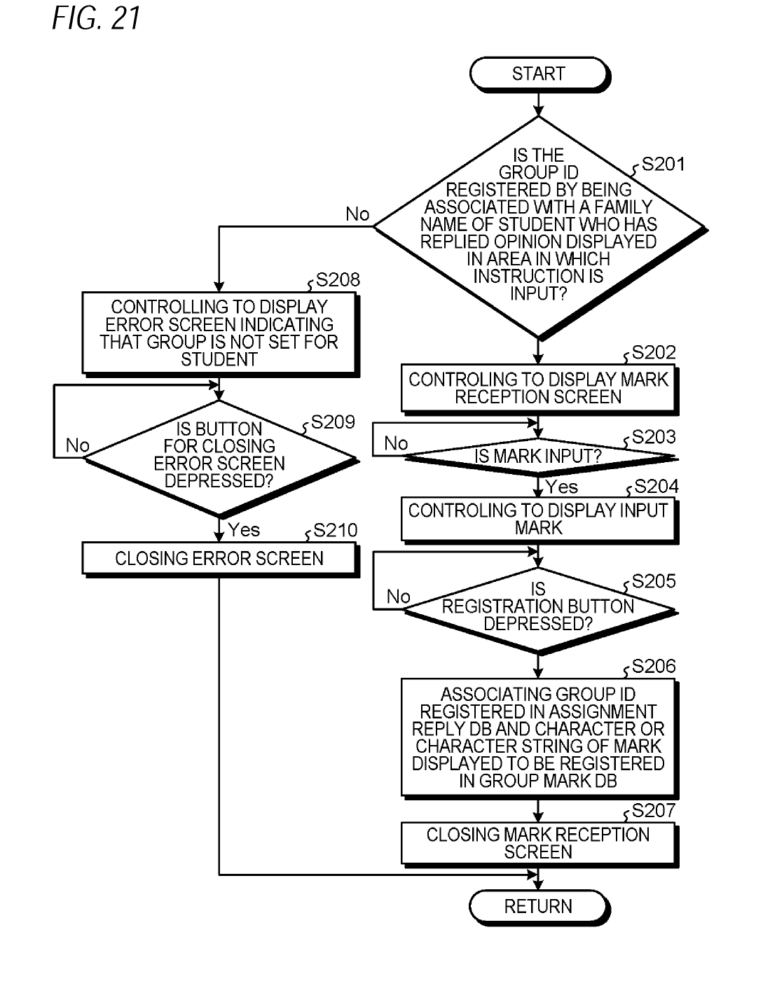

FIG. 21 is a flowchart illustrating the sequence of a mark reception process according to the embodiment. As illustrated in FIG. 21, the reception unit 15a determines whether the ID of the group is registered in the assignment reply DB 14c by being associated with a family name of a student who has replied the opinion displayed in the area in which the instruction to execute the mark reception process is input (S201).

When it is determined that the ID of the group is registered in the assignment reply DB 14c by being associated with the family name of the student who has replied the opinion displayed in the area in which the instruction to execute the mark reception process is input (“YES” at step S201), the reception unit 15a controls the projector 4b to display a mark reception screen for receiving a mark on the electronic blackboard 4a. Further, the reception unit 15a controls the display unit 12 to display the mark reception screen (S202).

Also, the reception unit 15a determines whether the character or character string indicating the mark is input into the area described above of the mark reception screen displayed on the electronic blackboard 4a, due to the manipulation of the electronic pen by the teacher. Further, the reception unit 15a determines whether the character or character string indicating the mark is input into the area described above of the mark reception screen displayed on the display unit 12, due to the manipulation of the touch pen or finger by the teacher (S203). When it is determined that the character or character string indicating the mark is not input (“NO” at step S203), the reception unit 15a performs the process of step S203 again.

In the meantime, when it is determined that the character or character string indicating the mark is input (“YES” at step S203), the reception unit 15a controls the projector 4b to display the character or character string indicating the input mark on the area described above of the mark reception screen displayed on the electronic blackboard 4a. Further, the reception unit 15a controls the display unit 12 to display the character or character string indicating the input mark on the area described above of the mark reception screen (S204).

Also, the reception unit 15a determines whether the registration button of the mark reception screen displayed on the electronic blackboard 4a is depressed due to the manipulation of the electronic pen by the teacher. Further, the reception unit 15a determines whether the registration button of the mark reception screen displayed on the display unit 12 is depressed due to the manipulation of the touch pen or finger by the teacher (S205). When it is determined that the registration button is not depressed (“NO” at step S205), the reception unit 15a performs the process of step S205 again.

In the meantime, when it is determined that the registration button is depressed (“YES” at step S205), the reception unit 15a specifies the ID of the group registered in the assignment reply DB 14c by being associated with a family name of student who has replied the opinion displayed on the area in which the instruction to execute the mark reception process is input. Also, the reception unit 15a specifies a record that the specified ID of the group is registered in the “group ID” field among all the records of the group-mark DB 14e. Also, the reception unit 15a registers the character or character string of the mark displayed on the area described above of the mark reception screen in the “mark character string” field of the specified record (S206). Also, the reception unit 15a closes the mark reception screen (S207) and stores the processed results in the internal memory and returns its control.

Further, when it is determined that the ID of the group is not registered in the assignment reply DB 14c by being associated with a family name of the student who has replied the opinion displayed on the area in which the instruction to execute the mark reception process (“NO” at step S201), the reception unit 15a controls the projector 4b to display an error screen indicating that the group is not set in relation to the student on the electronic blackboard 4a. Further, the reception unit 15a controls the display unit 12 to display the error screen (S208).

Also, the reception unit 15a determines whether the button for closing the error screen displayed on the electronic blackboard 4a is depressed due to the manipulation of the electronic pen by the teacher. Further, the reception unit 15a determines whether the button for closing the error screen displayed on the display unit 12 is depressed due to the manipulation of the touch pen or finger by the teacher (S209). When it is determined that the button for closing the error screen is not depressed (“NO” at step S209), the reception unit 15a performs the process of step S209 again.

In the meantime, when it is determined that the button for closing the error screen is depressed (“YES” at step S209), the reception unit 15a closes the error screen (S210) and stores the processed results in the internal memory and returns its control.

Referring back to the descriptions of FIG. 20A, the display control unit 15b determines whether an opinion to be displayed in an enlarged scale is designated from the opinions displayed on the electronic blackboard 4a in a matrix shape using the electronic pen by the teacher. Further, the display control unit 15b determines whether an opinion to be displayed in an enlarged scale is designated from the opinions displayed on the display unit 12 in a matrix shape using the touch or the finger by the teacher (S123). When it is determined that the opinion to be displayed in an enlarged scale is not designated (“NO” at step S123), the display control unit 15b proceeds to step S125 to be described below.

In the meantime, when it is determined that the opinion to be displayed in an enlarged scale is designated (“YES” at step S123), the display control unit 15b executes an opinion display process (S124).

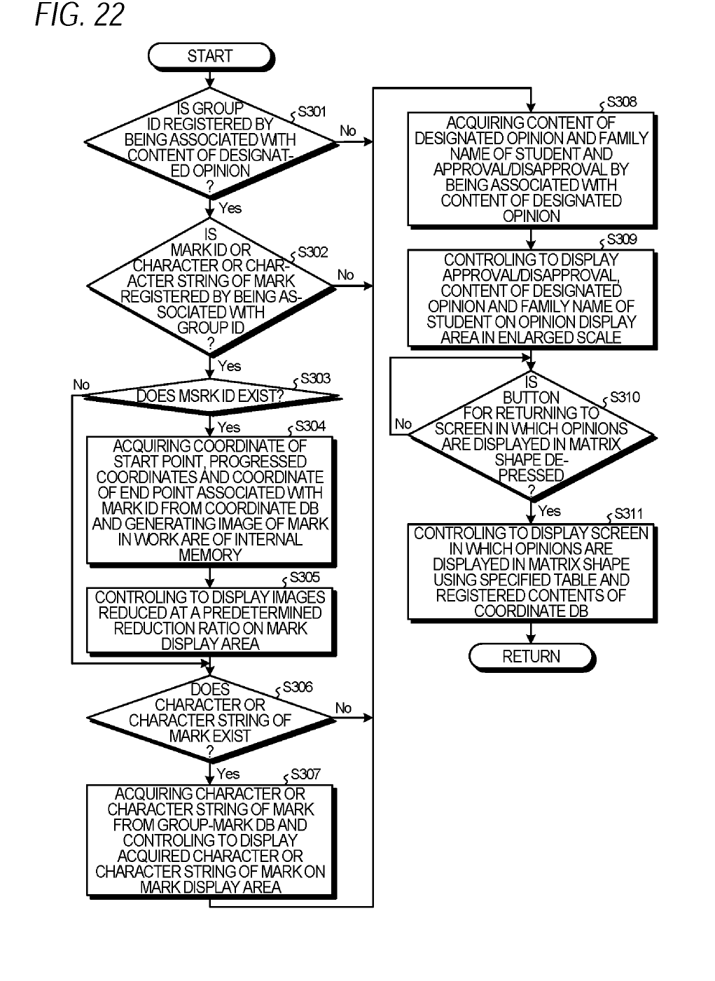

FIG. 22 is a flowchart illustrating a sequence of an opinion display process according to the embodiment. As illustrated in FIG. 22, the display control unit 15b determines whether the ID of the group is registered in the assignment reply DB 14c by being associated with the content of the designated opinion (S301). When it is determined that the ID of the group is not registered in the assignment reply DB 14c by being associated with the content of the designated opinion (“NO” at step S301), the display control unit 15b proceeds to step S308 to be described below.

In the meantime, when it is determined that the ID of the group is registered in the assignment reply DB 14c by being associated with the content of the designated opinion (“YES” at step S301), the display control unit 15b determines whether any one of the ID of the mark and the character or character string of the mark is registered in the group-mark DB 14e by being associated with the ID of the group determined as registered in the assignment reply DB 14c (S302). When it is determined that both the ID of the mark and the character or character string of the mark are not registered in the group-mark DB 14e by being associated with the ID of the group determined as registered in the assignment reply DB 14c (“NO” at step S302), the display control unit 15b proceeds to step S308.

When it is determined that any one the ID of the mark and the character or character string of the mark is registered in the group-mark DB 14e by being associated with the ID of the group determined as registered in the assignment reply DB 14c (“YES” at step S302), the display control unit 15b determines whether the ID of the mark exists among data determined as registered in the group-mark DB 14e (S303). When it is determined that the ID of the mark does not exist (“NO” at step S303), the display control unit 15b proceeds to step S306 to be described below.

In the meantime, when it is determined that the ID of the mark exists (“YES” at step S303), the display control unit 15b acquires the coordinate of the start point, the progressed coordinates and the coordinate of the end point associated with the ID of the mark from the coordinate DB 14d with respect to each of all the IDs of marks determined as registered in the group-mark DB 14e. Also, the display control unit 15b generates an image of the mark indicated (illustrated) by the acquired coordinate of the start point, progressed coordinates and coordinate of the end point on a work area of the internal memory of the control unit 15 using the acquired coordinate of the start point, progressed coordinates and coordinate of the end point with respect to each of all the IDs of marks determined as registered in the group-mark DB 14e (S304).

Also, the display control unit 15b reduces the generated image with respect to each of all the generated images of the marks at a predetermined reduction ratio. Subsequently, the display control unit 15b controls the projector 4b or the display unit 12 to display all the images reduced at a predetermined reduction ratio on a mark display area included in a screen when the designated opinion is displayed in an enlarged scale (S305).

Also, the display control unit 15b determines whether the character or character string of the mark exists among the data determined as registered in the group-mark DB 14e (S306). When it is determined that the character or character string of the mark does not exist (“NO” at step S306), the display control unit 15b proceeds to step S308.

In the meantime, when it is determined that the character or character string of the mark exists (“NO” at step S306), the display control unit 15b acquires each of all the characters or the character strings of the marks from the group-mark DB 14e. Subsequently, the display control unit 15b controls the projector 4b or the display unit 12 to display all the acquired characters or character strings of the marks from the group-mark DB 14e on the mark display area included in the screen when the designated opinion is displayed in an enlarged scale (S307).

Also, the display control unit 15b acquires the content of the designated opinion from the assignment reply DB 14c. Further, the display control unit 15b acquires the family name of student and the content of approval or disapproval registered by being associated with the content of the designated opinion from the assignment reply DB 14c (S308).

Also, the display control unit 15b controls the projector 4b or the display unit 12 to display the acquired content of approval or disapproval, content of the opinion and family name of student on the opinion display area in an enlarged scale (S309).

Also, the display control unit 15b determines whether the button for returning to the screen in which the opinion is displayed in a matrix shape is depressed due to the manipulation of the electronic pen by the teacher. Further, the display control unit 15b determines whether the button for returning to the screen in which the opinion is displayed in a matrix shape is depressed due to the manipulation of the touch pen or finger by the teacher (S310). When it is determined that the button for returning to the screen in which the opinion is displayed in a matrix shape is not depressed (“NO” at step S310), the display control unit 15b performs the process of step of S310 again.

In the meantime, when it is determined that the button for returning to the screen in which the opinion is displayed in a matrix shape is depressed (“YES” at step S310), the display control unit 15b acquires registered contents of the “student name” field, the “approval/disapproval” field, the “opinion content” field and the “opinion display area coordinate” field of all the records of the specified table 14c_1. Also, the display control unit 15b controls the projector 4b or the display unit 12 to display the screen in which the opinion is displayed in a matrix shape using the acquired registered contents. Further, the display control unit 15b acquires the coordinate of the start point, the progressed coordinates and the coordinate of the end point registered in the “start point coordinate” field, the “progressed coordinate” field and the “end point coordinate” field of all the records of the coordinate DB 14d, and controls the projector 4b or the display unit 12 to display each mark based on the acquired coordinate of the start point, progressed coordinates and coordinate of the end point on the opinion (S311), and stores the processed results in the internal memory and returns its control.

Referring back to the descriptions of FIG. 20A and FIG. 20B, when the opinion is display on the electronic blackboard 4a in a matrix shape, the reception unit 15a determines whether the button to end the display control is depressed due to the manipulation of the electronic pen by the teacher. Further, when the opinion is display on the display unit 12 in a matrix shape, the reception unit 15a determines whether the button to end the display control process is depressed due to the manipulation of the touch pen or finger by the teacher (S125).

When it is determined that the button to end the display control is not depressed (“NO” at step S125), the reception unit 15a goes back to step S110. In the meantime, when it is determined that the button to end the display control is depressed (“YES” at step S125), the reception unit 15a ends the display control process.

As described above, when each opinion included in the group of opinions is disposed and displayed on a different area among display areas in the display unit 12 or the electronic blackboard 4a, the teacher terminal 2 according to the embodiment receives registration of a mark by associating the mark with a plurality of opinions selected among the group of opinions. In a case where any one opinion included in the group of opinions is designated by the teacher, the teacher terminal 2 performs the following process when the designated opinion is included in a plurality of opinions selected from the group of opinions. That is, the teacher terminal 2 controls the projector 4b to display the mark, which is registered by being associated with the plurality of selected opinions, to be associated with the designated opinion on the electronic blackboard 4a. Further, the teacher terminal 2 controls the display unit 12 to display the mark, which is registered by being associated with the plurality of selected opinions, to be associated with the designated opinion. Accordingly, the entire mark that information on dividing into groups is displayed when the opinion designated by the teacher is displayed in an enlarged scale, according to the teacher terminal 2. Therefore, the teacher or the student may easily identify which group the opinion displayed in an enlarged scale belongs to. Accordingly, a convenience in displaying the designated opinion may be increased according to the teacher terminal 2.

Further, when a plurality of data are selected from the group of opinions, the teacher terminal 2 controls the projector 4b to display the mark reception screen for inputting the mark on the electronic blackboard 4a. Also, the teacher terminal 2 receives registration of the mark input to the mark reception screen by associating the mark with the plurality of selected opinions. As such, the teacher terminal 2 receives registration of the mark through the mark reception screen. Accordingly, a user such as a teacher may simply perform the registration of the mark according to the teacher terminal 2.

Further, the teacher terminal 2 receives the registration of the mark by associating the mark with a group to which a plurality of opinions selected from the group of opinions belongs, for each input mark. Also, when any one opinion included in the group of opinions is designated, the teacher terminal 2 controls the projector 4b or the display unit 12 to display all the marks registered by being associated with each of all the groups to which the designated opinion belongs. Accordingly, according to the teacher terminal 2, when the number of groups to which the designated opinion belongs is plural, the plurality of the marks registered by being associated with each of the groups may be displayed on the electronic blackboard 4a or the display unit 12.

Further, the teacher terminal 2 stores the coordinate of the mark in the storage unit 14 to be registered in the coordinate DB 14d by associating the coordinate of the mark with the plurality of opinions selected from the group of opinions. Also, in a case where any one opinion included in the group of opinions is designated, the teacher terminal 2 performs the following process when the designated opinion is included in the plurality of selected opinions. That is, the teacher terminal 2 acquires the coordinate of the mark registered by being associated with the plurality of selected opinions by associating the coordinate of the mark with the designated opinion, and generates the image of the mark using the acquired coordinate of the mark. Also, the teacher terminal 2 controls the projector 4b to display the generated image of the mark on the electronic blackboard 4a. Further, the teacher terminal 2 controls the display unit 12 to display the generated image of the mark. Accordingly, according to the teacher terminal 2, the image of the mark is generated using the coordinate of the start point each time when the opinion is designated, the progressed coordinates and the coordinate of the end point and thus, it is possible to suppress the reduction of capacity of the storage unit 14, which is capable of being used for storing, as compared to a case where the image of mark is stored in the storage unit 14 in advance.

While descriptions have been made on the embodiments of the disclosed apparatus, the present disclosure may be embodied in a variety of modifications in addition to the embodiments described above.

For example, all or some of processes described as performed automatically among the respective processes described in each embodiment may be performed manually. Further, all or some of processes described as being performed manually among the respective processes described in each embodiment may be performed automatically by a well-known method.

Further, it is possible to arbitrarily divide processing in each step of each process described in each embodiment into sub-processing or integrate the processing depending on various loads or use situations. Further, one or more of the steps may be omitted.

Further, a processing sequence in each step of each process described in each embodiment may be changed depending on various loads or use situations.

Further, each constituent of each device illustrated is a functional and/or conceptual component, and may not be required necessarily to have physically the same configuration as illustrated one. That is, specifics of distribution and/or integration of the devices is not limited to the illustrated specifics, and all or some of the specifics may be configured by distributing and/or integrating the devices functionally or physically at an any unit depending on various loads or use situations.

[Display Process Program]

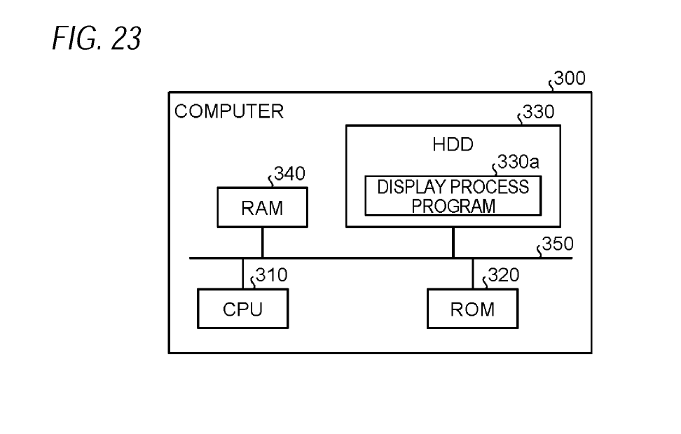

Further, various processes of the teacher terminal 2 described in the embodiments described above may be realized by allowing a program prepared in advance to be executed in a computer system such as a personal computer or a work station. Accordingly, in the following description, an example of a computer which executes a display process program and has the same function as the teacher terminal 2 described in the embodiment will be described with reference to FIG. 23. FIG. 23 is a view illustrating a computer that executes the display processing program.

As illustrated in FIG. 23, a computer 300 may include a CPU 310, a ROM 320, a HDD (Hard Disk Drive) 330 and a RAM 340. These equipments 310 to 340 may be connected with one another through, for example, a bus 350.

A basic program such as an Operating System (OS) may be stored in the ROM 320. Further, a display process program 330a which implements the same function as that of the reception unit 15a or the display control unit 15ba may be stored in the HDD 330 in advance. Further, various DBs stored in the storage unit 14 may be stored in the HDD 330.

Also, the CPU 310 may read out the display process program 330a from the HDD 330 and execute the display process program 330a.

Also, the CPU 310 may read out and store various DBs from and in the RAM 340. Further, the CPU 310 may execute the display process program 330a using various DBs stored in the RAM 340. Further, data intended to be stored in the RAM 340 may not be stored in its entirety. Data to be used for executing the process may be stored in the RAM 340.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display processing apparatus, comprising:
a reception unit configured to receive registration of a symbol by associating the symbol with a plurality of data selected from a group of data when each data included in the group of data is disposed and displayed on a different area among display areas by a display device; and
a display control unit configured to control the display device to display the symbol registered by being associated with the plurality of selected data, by associating the symbol with the designated data, when the designated data is included in the plurality of data, in a case where any one data included in the group of data is designated.

2. The display processing apparatus according to claim 1, wherein the reception unit is configured to receive the registration of the symbol input, by being associated with a plurality of data selected from the group of data, when the symbol is input within an area surrounded by a line of the symbol of which reception is completed.

3. The display processing apparatus according to claim 1, wherein the reception unit is configured to control the display device to display a screen for inputting the symbol when a plurality of data are selected from the group of data, and receive the registration of the symbol input in the screen by being associated with the plurality of selected data.

4. The display processing apparatus according to claim 1, wherein the reception unit is configured to receive the registration of the symbol by associating the symbol with a group to which the plurality of data selected from the group of data belong for each input symbol, and
the display control unit is configured to control the display device to display all the symbols registered by being associated with each of all the groups to which the designated data belongs when any one data included in the group of data is designated.

5. The display processing apparatus according to claim 1, wherein the reception unit is configured to store a coordinate of the symbol in a storage device by associating the coordinate of the symbol with the plurality of data selected from the group of data, and
the display control unit is configured to acquire the coordinate of the symbol registered by being associated with the plurality of selected data from the storage unit by associating the symbol with the designated data when the designated data is included in the plurality of data, generate an image of the symbol using the acquired coordinate of the symbol and control the display device to display the generated image of the symbol, in a case where any one data included in the group of data is designated.

6. The display processing apparatus according to claim 1, wherein the symbol is one of a character, a sign and a figure.

7. A system, comprising:
a display device; and
a terminal,
wherein the display device includes a display unit which performs display according to a control of the terminal,
the terminal includes:
a reception unit configured to control the display device to dispose and display each data included in a group of data in a different area are among display areas to receive registration of a symbol by associating the symbol with a plurality of data selected from the group of data when each data included in the group of data is disposed and displayed on the different area among display areas by the display device; and
a display control unit configured to control the display device to display the symbol registered by being associated with the plurality of selected data by associating the symbol with the designated data when the designated data is included in the plurality of data, in a case where any one data included in the group of data is designated.

8. A computer-readable storage medium storing a computer executable program that, when executed, causes a computer, to perform:
receiving registration of a symbol by associating the symbol with a plurality of data selected from the group of data when each data included in a group of data is disposed and displayed on a different area among display areas by a display device; and
controlling the display device to display the symbol registered by being associated with the plurality of selected data by associating the symbol with the designated data when the designated data is included in the plurality of data, in a case where any one data included in the group of data is designated.
